(19) United States
(12) Patent Application Publication
(10) Pub. No.: US 2019/0324612 A1
(43) Pub. Date: Oct. 24, 2019

(54) BULLET SCREEN DISPLAY METHOD AND APPARATUS

(71) Applicant: Alibaba Group Holding Limited, Grand Cayman (KY)

(72) Inventors: Jialin Du, Hangzhou (CN); Feng Zhang, Shanghai (CN)

(73) Assignee: Alibaba Group Holding Limited

(21) Appl. No.: 16/387,445

(22) Filed: Apr. 17, 2019

(30) Foreign Application Priority Data
Apr. 18, 2018 (CN) 201810348885.2

(51) Int. Cl. G06F 3/0484; G06F 3/0481

(52) U.S. Cl. CPC G06F 3/0484; G06F 3/0481

(57) ABSTRACT

A bullet screen display method including determining whether first bullet screen information comprises a question identifier when the first bullet screen information is received during playing of a multimedia resource; determining the first bullet screen information as question bullet screen information when the first bullet screen information comprises the question identifier; and displaying the first bullet screen information on a playing interface of the multimedia resource in a display mode corresponding to the question bullet screen information. The techniques of the present disclosure enrich display modes of bullet screen information and improve the effectiveness of interaction via the bullet screen information.

### CROSS REFERENCE TO RELATED PATENT APPLICATIONS

This application claims priority to Chinese Patent Application No. 201810348885.2 filed on 18 Apr. 2018 and entitled “BULLET SCREEN DISPLAY METHOD AND APPARATUS,” which are incorporated herein by reference in their entirety.

### TECHNICAL FIELD

The present disclosure relates to the field of computer technologies, and, more particularly, to bullet screen display methods and apparatuses.

### BACKGROUND

Bullet screen is one way of commenting in which comment content may be displayed in multimedia content (such as video or audio). For example, in the process of playing a drama series, a user may make a comment by releasing bullet screen information and interact with other users through the bullet screen information. Nowadays, users have increasingly urgent demands on effective interaction through bullet screen information.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

A bullet screen display method and apparatus are proposed in this disclosure, which enrich display modes of bullet screen information and improve the effectiveness of interaction via the bullet screen information.

According to an example of this disclosure, a bullet screen display method applied in a terminal is provided, comprising:

determining whether first bullet screen information includes a question identifier when the first bullet screen information is received during playing of a multimedia resource;

determining the first bullet screen information as question bullet screen information when the first bullet screen information includes a question identifier; and

displaying the first bullet screen information on a playing interface of the multimedia resource in a display mode corresponding to the question bullet screen information.

In an example implementation, the method further comprises:

displaying a bullet screen information input interface upon detection of a trigger operation for the first bullet screen information; and

sending second bullet screen information when a control for sending bullet screen information is triggered, wherein the second bullet screen information includes the question identifier of the first bullet screen information, and the question identifier is used for enabling a server to establish a question-answer association between the first bullet screen information and the second bullet screen information according to the question identifier.

For example, the second bullet screen information is bullet screen information replied by a user when the first bullet screen information is presented at a display

In an example implementation, the method further comprises:

displaying a bullet screen information input interface when a control for editing bullet screen information is triggered;

displaying question tag information in an information input area of the bullet screen information input interface when a question control in the bullet screen information input interface is triggered, wherein the question tag information is used for indicating that the type of third bullet screen information to be input is candidate question bullet screen information; and

sending the third bullet screen information when a control for sending bullet screen information is triggered, wherein the third bullet screen information includes a candidate question identifier, so that a server determines the type of the third bullet screen information according to the candidate question identifier.

For example, the third bullet screen information is a question bullet screen sent by the user.

In an example implementation, the method further comprises:

determining whether fourth bullet screen information includes the answer identifier when the fourth bullet screen information is received; and

sending a prompt notification on the playing interface of the multimedia resource when the fourth bullet screen information includes an answer identifier indicating that the fourth bullet screen information is recommended answer bullet screen information for the third bullet screen information.

For example, the fourth bullet screen information is determined by a server as the recommended answer bullet screen information for the third bullet screen information.

In an example implementation, the method further comprises:

acquiring fifth bullet screen information to be displayed when the multimedia resource is played to a target time point, wherein the fifth bullet screen information is question bullet screen information related to the multimedia resource at the target time point; and

displaying the fifth bullet screen information in a display mode corresponding to the fifth bullet screen information.

For example, the fifth bullet screen information is the question bullet screen information played at the target time point.

In an example implementation, the method further comprises:

sending a reply displaying request for the fifth bullet screen information to a server upon detection of a trigger operation for the fifth bullet screen information; and

displaying first reply information in a target display area in the playing interface of the multimedia resource when the first reply information for the fifth bullet screen information in a discussion page returned by the server is received.

For example, the first reply information is a content displayed in the playing interface, such as in a half screen, after the fifth bullet screen information is clicked.

According to another example of this disclosure, a bullet screen display method applied in a server is provided, comprising:

determining question bullet screen information in multiple pieces of bullet screen information for a multimedia resource, wherein the question bullet screen information includes a question identifier; and

sending the question bullet screen information to a terminal playing the multimedia resource, so that the terminal displays the question bullet screen information in a display mode corresponding to the question bullet screen information.

In an example implementation, the step of determining question bullet screen information in multiple pieces of bullet screen information for a multimedia resource includes:

determining multiple pieces of candidate question bullet screen information for the multimedia resource; and

determining the question bullet screen information from the multiple pieces of candidate question bullet screen information.

In an example implementation, the step of determining multiple pieces of candidate question bullet screen information for the multimedia resource includes:

determining bullet screen information including a question keyword as the candidate question bullet screen information.

In an example implementation, the method further comprises:

determining answer bullet screen information corresponding to the question bullet screen information, wherein the answer bullet screen information includes an answer identifier, and the answer identifier is used for indicating that the answer bullet screen information is answer bullet screen information corresponding to the question bullet screen information.

In an example implementation, determining answer bullet screen information corresponding to the question bullet screen information includes at least one of the following manners:

determining target bullet screen information matching the question keyword as candidate answer bullet screen information, and determining the answer bullet screen information from the candidate answer bullet screen information, wherein the target bullet screen information is bullet screen information that is received by the server in a target time interval after the question bullet screen information is displayed;

receiving second bullet screen information sent by the terminal, and determining the second bullet screen information as the answer bullet screen information, wherein the second bullet screen information includes the question identifier of the question bullet screen information; and

acquiring shared information associated with the question bullet screen information from a sharing platform, and determining the answer bullet screen information according to the shared information.

In an example implementation, the method further comprises:

sending related data of the question bullet screen information and the answer bullet screen information to a discussion page, so that the related data of the question bullet screen information and the answer bullet screen information is displayed on the discussion page.

In an example implementation, the method further comprises:

acquiring second reply information for the question bullet screen information in the discussion page; and

sending the second reply information to the terminal playing the multimedia resource, so that the terminal displays the second reply information in a display mode corresponding to bullet screen information.

For example, the second reply information is a new reply content after the question bullet screen information and the answer bullet screen information are displayed in the discussion page.

In an example implementation, the method further comprises:

determining a target time point of the multimedia resource and fifth bullet screen information corresponding to the target time point; and

sending the fifth bullet screen information when an acquisition request of the terminal for the fifth bullet screen information is received, so that the terminal displays the fifth bullet screen information in a display mode corresponding to the fifth bullet screen information.

In an example implementation, the method further comprises:

determining first reply information for the fifth bullet screen information in a discussion page when a reply displaying request sent by the terminal for the fifth bullet screen information is received; and

sending the first reply information to the terminal, so that the terminal displays the first reply information in a target display area in a playing interface of the multimedia resource.

According to an example of this disclosure, a bullet screen display apparatus applied in a terminal is provided, comprising:

a first determining module configured to determine whether first bullet screen information includes a question identifier when the first bullet screen information is received during playing of a multimedia resource;

a second determining module configured to determine the first bullet screen information as question bullet screen information when the first bullet screen information includes a question identifier; and

a first display module configured to display the first bullet screen information on a playing interface of the multimedia resource in a display mode corresponding to the question bullet screen information.

In an example implementation, the apparatus further comprises:

a second display module configured to display a bullet screen information input interface upon detection of a trigger operation for the first bullet screen information; and

a first sending module configured to send second bullet screen information when a control for sending bullet screen information is triggered, wherein the second bullet screen information includes the question identifier of the first bullet screen information, and the question identifier is used for enabling a server to establish a question-answer association between the first bullet screen information and the second bullet screen information according to the question identifier.

In an example implementation, the apparatus further comprises:

a third display module configured to display a bullet screen information input interface when a control for editing bullet screen information is triggered;

a fourth display module configured to display question tag information in an information input area of the bullet screen information input interface when a question control in the bullet screen information input interface is triggered, wherein the question tag information is used for indicating that the type of third bullet screen information to be input is candidate question bullet screen information; and

a second sending module configured to send the third bullet screen information when a control for sending bullet screen information is triggered, wherein the third bullet screen information includes a candidate question identifier, so that a server determines the type of the third bullet screen information according to the candidate question identifier.

In an example implementation, the apparatus further comprises:

a third determining module configured to determine whether fourth bullet screen information includes an answer identifier when the fourth bullet screen information is received; and

a prompt notification sending module configured to send a prompt notification on the playing interface of the multimedia resource when the fourth bullet screen information includes an answer identifier indicating that the fourth bullet screen information is recommended answer bullet screen information for the third bullet screen information.

In an example implementation, the apparatus further comprises:

an acquisition module configured to acquire fifth bullet screen information to be displayed when the multimedia resource is played to a target time point, wherein the fifth bullet screen information is question bullet screen information related to the multimedia resource at the target time point; and

a fifth display module configured to display the fifth bullet screen information in a display mode corresponding to the fifth bullet screen information.

In an example implementation, the apparatus further comprises:

a request sending module configured to send a reply displaying request for the fifth bullet screen information to a server upon detection of a trigger operation for the fifth bullet screen information; and

a sixth display module configured to display first reply information in a target display area in the playing interface of the multimedia resource when the first reply information for the fifth bullet screen information in a discussion page returned by the server is received.

According to an example of this disclosure, a bullet screen display apparatus applied in a server is provided, comprising:

a first information determining module configured to determine question bullet screen information in multiple pieces of bullet screen information for a multimedia resource, wherein the question bullet screen information includes a question identifier; and

a first information sending module configured to send the question bullet screen information to a terminal playing the multimedia resource, so that the terminal displays the question bullet screen information in a display mode corresponding to the question bullet screen information.

In an example implementation, the first information determining module includes:

a first determining sub-module configured to determine multiple pieces of candidate question bullet screen information for the multimedia resource; and

a second determining sub-module configured to determine the question bullet screen information from the multiple pieces of candidate question bullet screen information.

In an example implementation, the first determining sub-module is configured to:

determine bullet screen information including a question keyword as the candidate question bullet screen information.

In an example implementation, the apparatus further comprises:

a second information determining module configured to determine answer bullet screen information corresponding to the question bullet screen information, wherein the answer bullet screen information includes an answer identifier, and the answer identifier is used for indicating that the answer bullet screen information is answer bullet screen information corresponding to the question bullet screen information.

In an example implementation, the second information determining module includes at least one of the following sub-modules:

a third determining sub-module configured to determine target bullet screen information matching the question keyword as candidate answer bullet screen information, and determine the answer bullet screen information from the candidate answer bullet screen information, wherein the target bullet screen information is bullet screen information that is received by the server in a target time interval after the question bullet screen information is displayed;

a fourth determining sub-module configured to receive second bullet screen information sent by the terminal, and determine the second bullet screen information as the answer bullet screen information, wherein the second bullet screen information includes the question identifier of the question bullet screen information; and

a fifth determining sub-module configured to acquire shared information associated with the question bullet screen information from a sharing platform, and determine the answer bullet screen information according to the shared information.

In an example implementation, the apparatus further comprises:

a data sending module configured to send related data of the question bullet screen information and the answer bullet screen information to a discussion page, so that the related data of the question bullet screen information and the answer bullet screen information is displayed on the discussion page.

In an example implementation, the apparatus further comprises:

an information acquisition module configured to acquire second reply information for the question bullet screen information in the discussion page; and

a second information sending module configured to send the second reply information to the terminal playing the multimedia resource, so that the terminal displays the second reply information in a display mode corresponding to bullet screen information.

In an example implementation, the apparatus further comprises:

a third information determining module configured to determine a target time point of the multimedia resource and fifth bullet screen information corresponding to the target time point; and

a third information sending module configured to send the fifth bullet screen information when an acquisition request of the terminal for the fifth bullet screen information is received, so that the terminal displays the fifth bullet screen information in a display mode corresponding to the fifth bullet screen information.

In an example implementation, the apparatus further comprises:

a fourth information determining module configured to determine first reply information for the fifth bullet screen information in a discussion page when a reply displaying request sent by the terminal for the fifth bullet screen information is received; and

a fourth information sending module configured to send the first reply information to the terminal, so that the terminal displays the first reply information in a target display area in a playing interface of the multimedia resource.

According to another example of this disclosure, a bullet screen display apparatus is provided, comprising: a first processor; and a first memory configured to store instructions executable by the first processor, wherein the first processor is configured to perform the foregoing method.

According to another example of this disclosure, a non-volatile computer-readable storage medium having computer program instructions stored thereon is provided, wherein the foregoing bullet screen display method is implemented when the computer program instructions are executed by a first processor.

According to another example of this disclosure, a bullet screen display apparatus is provided, comprising: a second processor; and a second memory configured to store instructions executable by the second processor, wherein the second processor is configured to perform the foregoing method.

According to another example of this disclosure, a non-volatile computer-readable storage medium having computer program instructions stored thereon is provided, wherein the foregoing bullet screen display method is implemented when the computer program instructions are executed by a second processor.

According to the example embodiments of this disclosure, the techniques of this disclosure determine whether first bullet screen information includes a question identifier when the first bullet screen information is received during playing of a multimedia resource. The first bullet screen information is determined as question bullet screen information when the first bullet screen information includes a question identifier, and the first bullet screen information is displayed in a display mode corresponding to the question bullet screen information, thereby enriching display modes of bullet screen information and improving the effectiveness of interaction via the bullet screen information.

Other features and aspects of this disclosure will become clear according to the following detailed description about the example embodiments with reference to the accompanying drawings.

### BRIEF DESCRIPTION OF THE DRAWINGS

In order to illustrate the technical solutions in the example embodiments of the present disclosure more clearly, the following briefly describes the accompanying drawings which aid in describing the example embodiments. Apparently, the accompanying drawings in the following description merely show some of the example embodiments of the present disclosure, and persons of ordinary skill in the art may derive other drawings from these accompanying drawings without creative efforts.

FIG. 1 is a flowchart of a bullet screen display method according to an example embodiment.

FIG. 2 is a schematic diagram of an application scenario of a bullet screen display method according to an example embodiment.

FIG. 3 is a flowchart of a bullet screen display method according to an example embodiment.

FIG. 4 is a schematic diagram of an application scenario of a bullet screen display method according to an example embodiment.

FIG. 5 is a flowchart of a bullet screen display method according to an example embodiment.

FIG. 6 is a schematic diagram of an application scenario of a bullet screen display method according to an example embodiment.

FIG. 7 is a flowchart of a bullet screen display method according to an example embodiment.

FIG. 8 is a schematic diagram of an application scenario of a bullet screen display method according to an example embodiment.

FIG. 9 is a flowchart of a bullet screen display method according to an example embodiment.

FIG. 10 is a schematic diagram of an application scenario of a bullet screen display method according to an example embodiment.

FIG. 11 is a flowchart of a bullet screen display method according to an example embodiment.

FIG. 12 is a schematic diagram of an application scenario of a bullet screen display method according to an example embodiment.

FIG. 13 is a flowchart of a bullet screen display method according to an example embodiment.

FIG. 14 is a flowchart of a bullet screen display method according to an example embodiment.

FIG. 15 is a flowchart of a bullet screen display method according to an example embodiment.

FIG. 16 is a flowchart of a bullet screen display method according to an example embodiment.

FIG. 17 is a flowchart of a bullet screen display method according to an example embodiment.

FIG. 18 is a flowchart of a bullet screen display method according to an example embodiment.

FIG. 19 is a flowchart of a bullet screen display method according to an example embodiment.

FIG. 20 is a flowchart of a bullet screen display method according to an example embodiment.

FIG. 21a and FIG. 21b are each a schematic diagram of an application scenario of a bullet screen display method according to an example embodiment.

FIG. 22 is a block diagram of a bullet screen display apparatus according to an example embodiment.

FIG. 23 is a block diagram of a bullet screen display apparatus according to an example embodiment.

FIG. 24 is a block diagram of a bullet screen display apparatus according to an example embodiment.

FIG. 25 is a block diagram of a bullet screen display apparatus according to an example embodiment.

FIG. 26 is a block diagram of a bullet screen display apparatus according to an example embodiment.

FIG. 27 is a block diagram of a bullet screen display apparatus according to an example embodiment.

### DETAILED DESCRIPTION

Various example embodiments, features and aspects of this disclosure will be described in detail with reference to the accompanying drawings. The same reference numerals in the drawings represent the same or similar elements. Although various aspects of the embodiments are shown in the drawings, the drawings are not necessarily drawn to scale, unless otherwise specified.

The specific term “example” here means “as an example or embodiment, or illustrative.” Any embodiment illustrated as an “example” one is not necessarily explained as superior to or better than other embodiments.

In addition, to better illustrate this disclosure, numerous details are provided in the following specific implementations. Those skilled in the art should understand that this disclosure may also be implemented without some specific details. In some examples, methods, means, elements and circuits well known to those skilled in the art are not described in detail, so that the subject of this disclosure is emphasized.

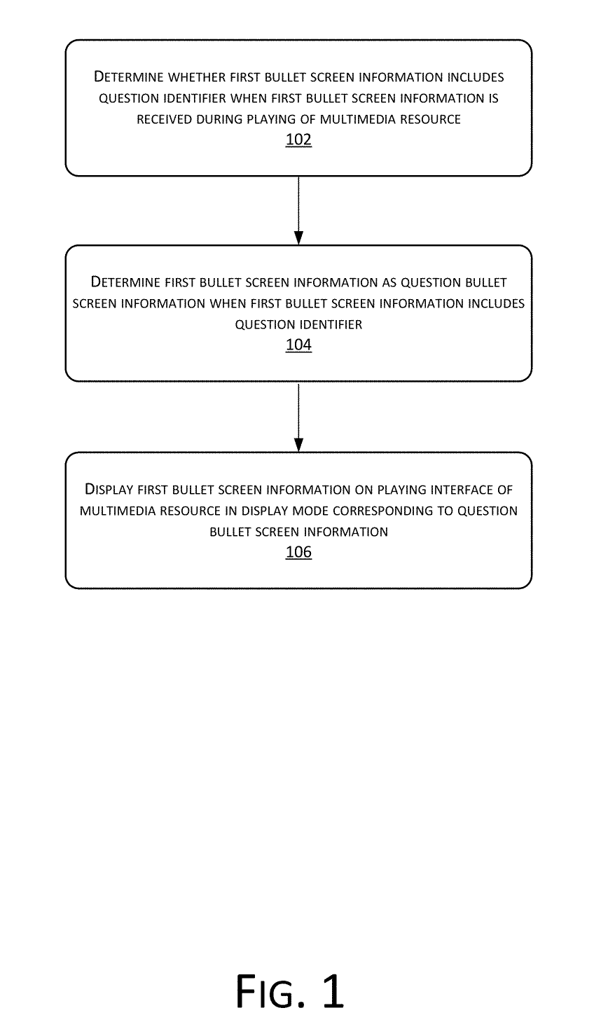

FIG. 1 is a flowchart of a bullet screen display method according to an example embodiment. The method may be applied in a terminal, such as a mobile phone, a tablet computer, or the like, which is not limited in this disclosure. As shown in FIG. 1, the bullet screen display method according to the embodiment of this disclosure includes the following steps:

In step S102, when first bullet screen information is received during playing of a multimedia resource, whether the first bullet screen information includes a question identifier is determined.

In step S104, the first bullet screen information is determined as question bullet screen information when the first bullet screen information includes a question identifier.

In step S106, the first bullet screen information is displayed on a playing interface of the multimedia resource in a display mode corresponding to the question bullet screen information.

According to the embodiments of this disclosure, it is determined whether first bullet screen information includes a question identifier when the first bullet screen information is received during playing of a multimedia resource; the first bullet screen information is determined as question bullet screen information when the first bullet screen information includes a question identifier; and the first bullet screen information is displayed on a playing interface of the multimedia resource in a display mode corresponding to the question bullet screen information. The first bullet screen information, which belongs to the type of question bullet screen information, is displayed on the playing interface of the multimedia resource in the display mode corresponding to the question bullet screen information, thereby enriching display modes of bullet screen information and modes of interaction with the multimedia resource, and improving the effectiveness of interaction via the bullet screen information.

The question bullet screen information may be a specific type of bullet screen information determined by a server from multiple pieces of bullet screen information for the multimedia resource. The question bullet screen information may include various types of question content, for example, question content related to the multimedia resource. Users may answer the question bullet screen information, thus implementing interactive question and answer between the users through bullet screen information. The question identifier may be an identifier that is added by the server after performing data processing on bullet screen information belonging to the type of question bullet screen information, for indicating that the bullet screen information is the question bullet screen information. Forms of the question bullet screen information and question identifier are not limited in this disclosure.

For example, a user A plays a multimedia resource, wherein the multimedia resource may be a video, an audio, or the like, which is not limited in this disclosure. For example, during playing of a drama series, a bullet screen function of a terminal of the user A has been enabled (for example, a control for enabling the bullet screen function has been triggered before). The terminal may receive multiple pieces of bullet screen information (first bullet screen information) sent by the server. In this case, when receiving the first bullet screen information, the terminal determines whether the first bullet screen information includes a question identifier. When the first bullet screen information includes a question identifier, the terminal confirms that the first bullet screen information is question bullet screen information. The terminal displays, on a playing interface of the multimedia resource, the first bullet screen information in a display mode corresponding to the question bullet screen information.

The display mode corresponding to the question bullet screen information may include multiple forms. For example, a question icon (such as a question mark) may be added in front of the first bullet screen information, and a reply button may be added behind the first bullet screen information; the whole first bullet screen information may be clicked, or the like. The display mode corresponding to the question bullet screen information may be predetermined by the server, or set by default by a terminal system, or may be customized by the user. The form, setting manner, and the like of the display mode corresponding to the question bullet screen information is not limited in this disclosure.

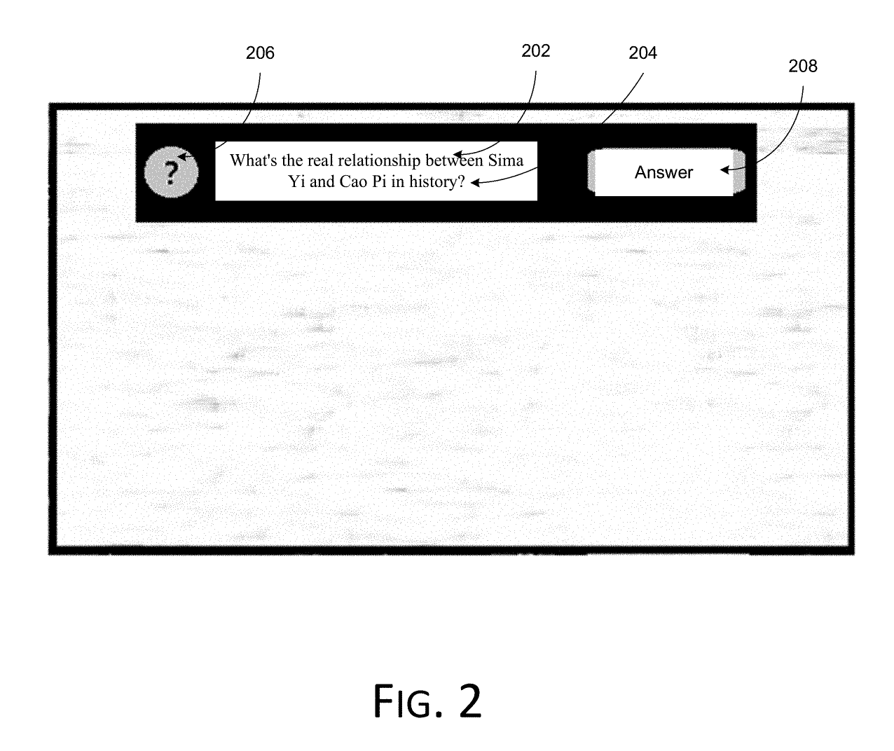

FIG. 2 is a schematic diagram of an application scenario of a bullet screen display method according to an example embodiment. In an example implementation, as shown in FIG. 2, during playing of a drama series, a terminal receives multiple pieces of first bullet screen information, wherein one piece of first bullet screen information (for example, bullet screen information sent by a user B, wherein the bullet screen information includes the following content 202: What's the real relationship between Sima Yi and Cao Pi in history?) includes a question identifier 204. The terminal confirms that this piece of first bullet screen information is question bullet screen information, and displays, on a playing interface of the drama series, the first bullet screen information in a display mode corresponding to the question bullet screen information. For example, as shown in FIG. 2, a question icon 206 (such as a question mark) is added in front of the first bullet screen information, and an answer control 208 is added behind the first bullet screen information.

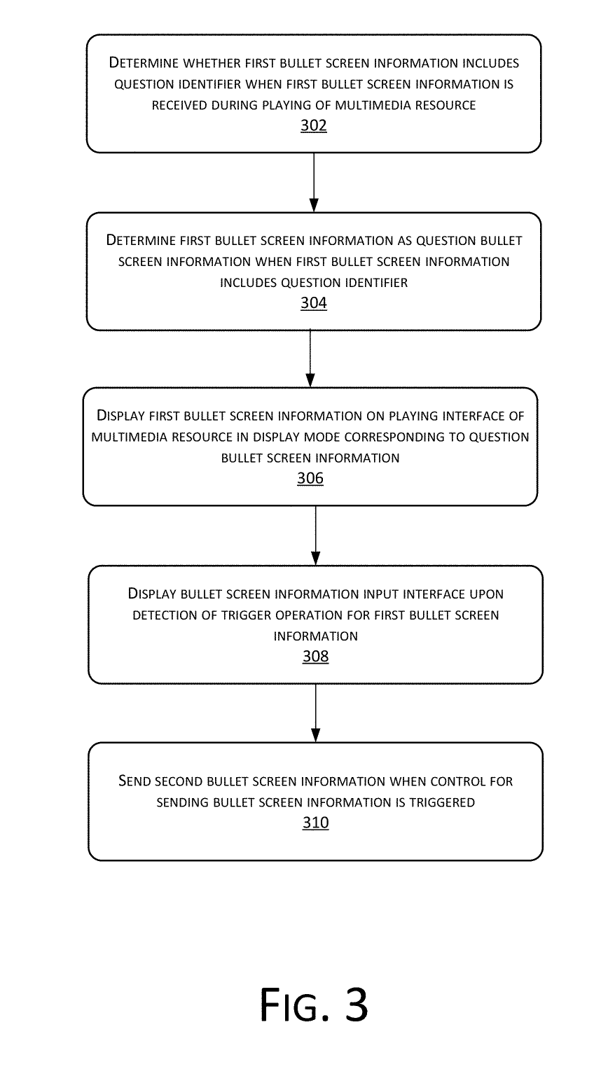

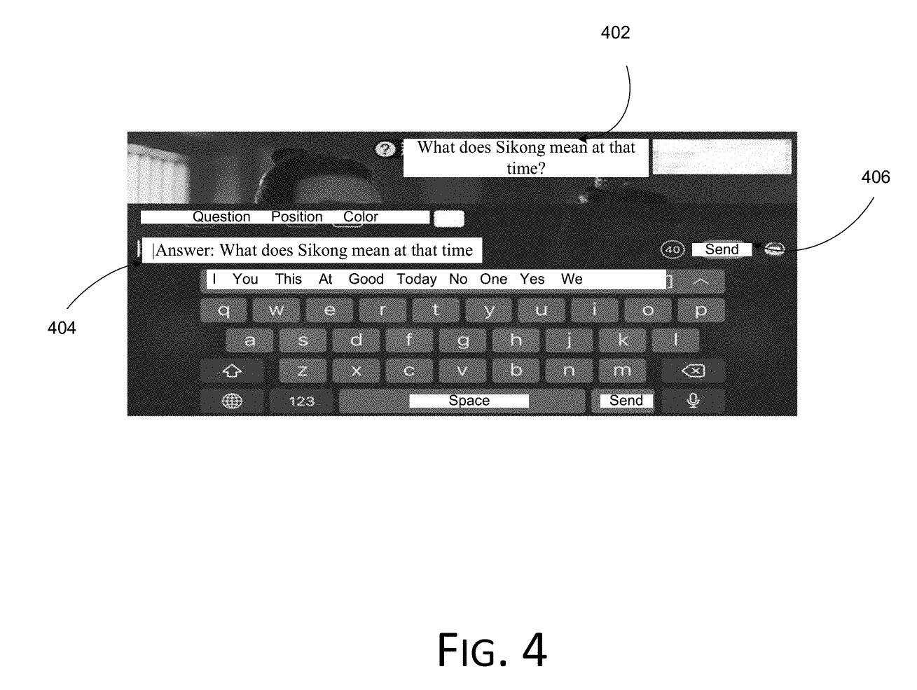

FIG. 3 is a flowchart of a bullet screen display method according to an example embodiment. FIG. 4 is a schematic diagram of an application scenario of a bullet screen display method according to an example embodiment. In an example implementation, as shown in FIG. 3, the method further includes the following steps:

In step S302, when first bullet screen information is received during playing of a multimedia resource, whether the first bullet screen information includes a question identifier is determined.

In step S304, the first bullet screen information is determined as question bullet screen information when the first bullet screen information includes a question identifier.

In step S306, the first bullet screen information is displayed on a playing interface of the multimedia resource in a display mode corresponding to the question bullet screen information.

In step S308, a bullet screen information input interface is displayed upon detection of a trigger operation for the first bullet screen information.

In step S310, second bullet screen information is sent when a control for sending bullet screen information is triggered, wherein the second bullet screen information includes the question identifier of the first bullet screen information, and the question identifier is used for enabling a server to establish a question-answer association between the first bullet screen information and the second bullet screen information according to the question identifier.

The second bullet screen information may refer to bullet screen information with which the user replies to the first bullet screen information (which is question bullet screen information).

For example, the user A sees a piece of first bullet screen information al (which is question bullet screen information). For example, as shown in FIG. 4, the first bullet screen information 402 is “What does Sikong mean at that time.” The user A is willing to share and answer the question to show his/her knowledge. In this case, the user A may trigger the first bullet screen information al. When detecting the trigger operation for the first bullet screen information al, the terminal may display a bullet screen information input interface for the user to edit bullet screen information. As shown in FIG. 4, the terminal displays the bullet screen information input interface, and a default text 404, such as “Answer: What does Sikong mean at that time,” may be displayed in an input field in the bullet screen information input interface, to prompt the user that the edited bullet screen information is bullet screen information for replying to the question bullet screen information (What does Sikong mean at that time). The form and content of the bullet screen information input interface are not limited in this disclosure.

After inputting the content of the bullet screen information, the user may trigger the control for sending bullet screen information (for example, the sending control 406 shown in FIG. 4), and the terminal sends second bullet screen information. For example, the terminal sends the second bullet screen information to the server. It should be understood that the second bullet screen information may include many forms. For example, the second bullet screen information may be a text-type, audio-type, picture-type, and other types of bullet screen information. When sending the second bullet screen information to the server, the terminal may add the question identifier of the first bullet screen information al to the second bullet screen information, so that the server may establish a question-answer association between the first bullet screen information and the second bullet screen information according to the question identifier.

The question-answer association may be configured for representing a corresponding relationship between the first bullet screen information (the question bullet screen information) and the second bullet screen information (the bullet screen information for replying to the first bullet screen information). For example, when the server receives the second bullet screen information, because the second bullet screen information includes the question identifier of the first bullet screen information al, the server may determine that the second bullet screen information is the bullet screen information for replying to the first bullet screen information al, thereby establishing a corresponding relationship between the two.

In this manner, the user may conveniently reply to the first bullet screen information that belongs to the type of question bullet screen information, thereby enriching modes of interaction with the multimedia resource, and improving the effectiveness of interaction between users.

Those skilled in the art should understand that the terminal may preset a condition for displaying the bullet screen information input interface. For example, as described above, the condition of the bullet screen information input interface may be displayed upon detection of the trigger operation for the first bullet screen information. In this case, the bullet screen information input interface may be displayed upon detection that the user triggers the first bullet screen information. The terminal may further display a group of controls upon detection of the trigger operation for the first bullet screen information, including, for example, a control 1 (such as a “like” control), a control 2 (such as a “dislike” control), and a control 3 (such as a “reply” control). In this case, the bullet screen information input interface is displayed upon detection that the user triggers the control 3, which is not limited in this disclosure.

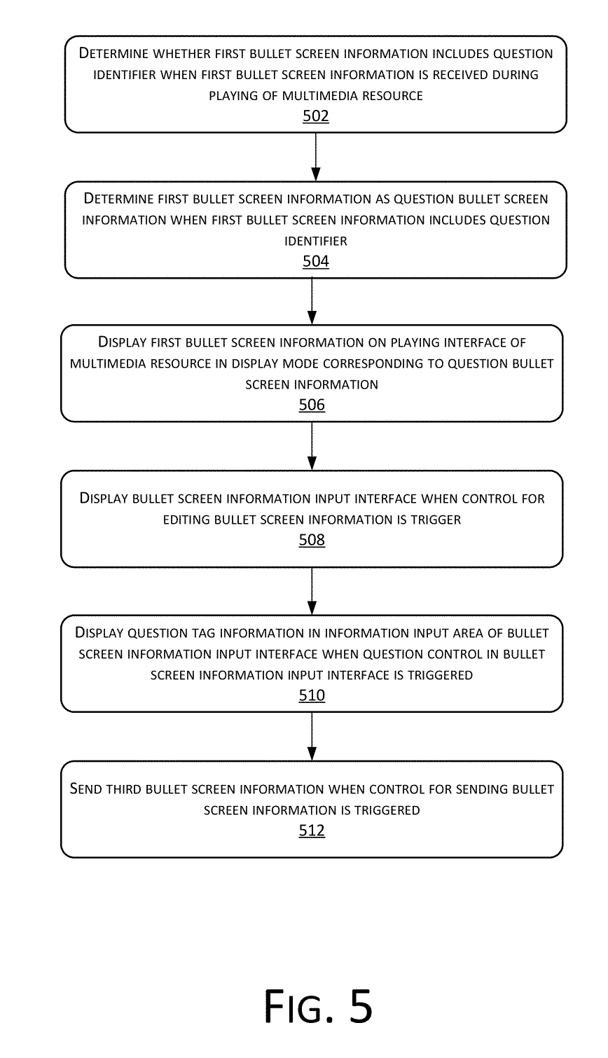

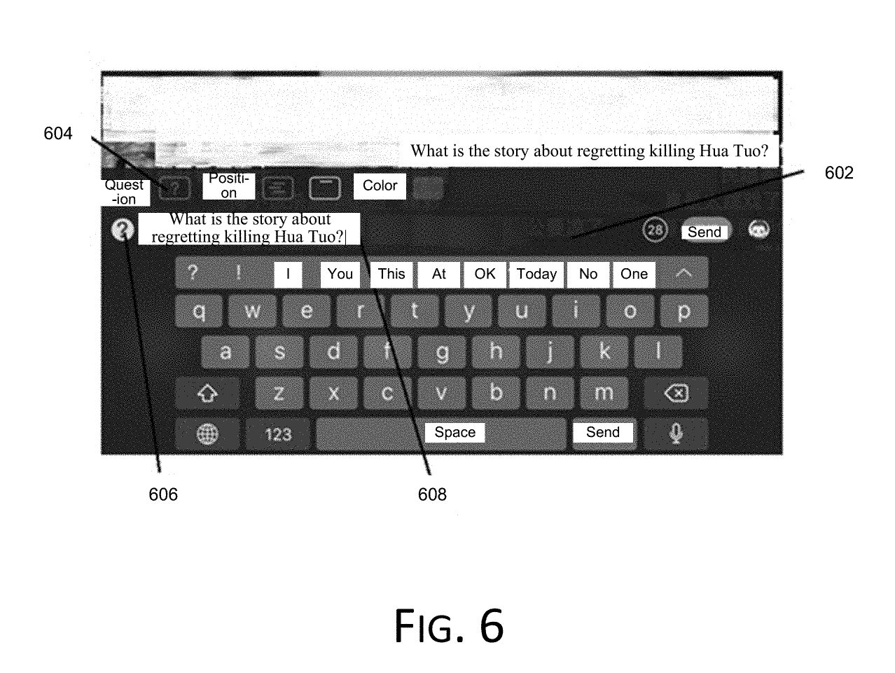

FIG. 5 is a flowchart of a bullet screen display method according to an example embodiment. FIG. 6 is a schematic diagram of an application scenario of a bullet screen display method according to an example embodiment. In an example implementation, as shown in FIG. 5, the method further includes the following steps:

In step S502, when first bullet screen information is received during playing of a multimedia resource, whether the first bullet screen information includes a question identifier is determined.

In step S504, the first bullet screen information is determined as question bullet screen information when the first bullet screen information includes a question identifier.

In step S506, the first bullet screen information is displayed on a playing interface of the multimedia resource in a display mode corresponding to the question bullet screen information.

In step S508, the bullet screen information input interface is displayed when a control for editing bullet screen information is triggered.

In step S510, question tag information is displayed in an information input area of the bullet screen information input interface when a question control in the bullet screen information input interface is triggered, wherein the question tag information is used for indicating that the type of third bullet screen information to be input is candidate question bullet screen information.

In step S512, the third bullet screen information is sent when a control for sending bullet screen information is triggered, wherein the third bullet screen information includes a candidate question identifier, so that a server determines the type of the third bullet screen information according to the candidate question identifier.

For example, the user A comes up with a question, such as a question about the plot, during playing of a drama series, and wants to get the answer. In this case, the user A may choose to send bullet screen information including the question. For example, the user A may trigger a control for editing bullet screen information. At this point, the terminal may display a bullet screen information input interface when the control for editing the bullet screen information is triggered. The displayed bullet screen information input interface may include a question control. For example, as shown in FIG. 6, the displayed bullet screen information input interface 602 may include a question control 604. Upon detection that the question control 604 in the bullet screen information input interface 602 is triggered, the terminal displays a question tag information 606 (such as a question mark icon) in an information input area 608 of the bullet screen information input interface 602. The question tag information may be used for indicating that the type of third bullet screen information to be input is candidate question bullet screen information. The candidate question bullet screen information may refer to bullet screen information that is input or sent by the user and includes a question expected to be answered. The form of the question control, the form of the information input area, and the form and content of question tag information are not limited in this disclosure.

Upon detection that the control for sending bullet screen information is triggered, the terminal may send the third bullet screen information. The third bullet screen information includes the candidate question identifier, so that the server determines the type of the third bullet screen information according to the candidate question identifier. The candidate question identifier may be an identifier that is added to the third bullet screen information by the terminal when sending the third bullet screen information, and may be configured for representing the type of the third bullet screen information. For example, the candidate question identifier may be configured for identifying that the third bullet screen information is bullet screen information (candidate question bullet screen information) sent by a user and expected to be answered. The form and content of the candidate question identifier are not limited in this disclosure.

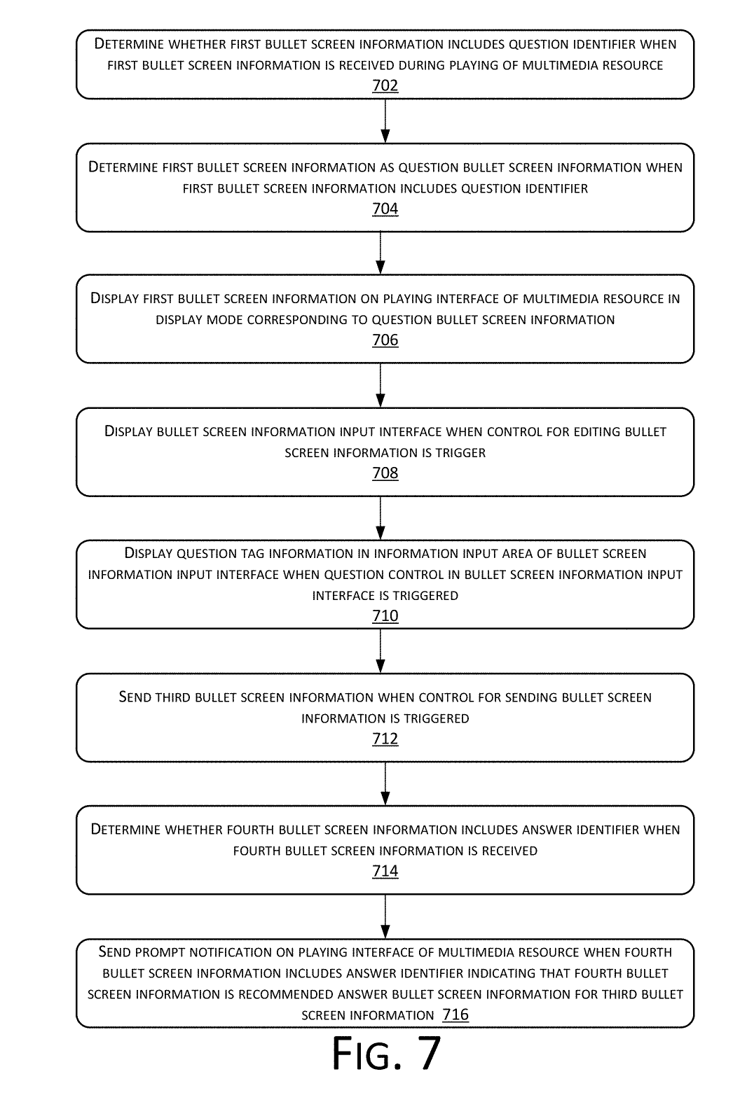

FIG. 7 is a flowchart of a bullet screen display method according to an example embodiment. In an example implementation, as shown in FIG. 7, the method further includes the following steps:

In step S702, when first bullet screen information is received during playing of a multimedia resource, whether the first bullet screen information includes a question identifier is determined.

In step S704, the first bullet screen information is determined as question bullet screen information when the first bullet screen information includes a question identifier.

In step S706, the first bullet screen information is displayed on a playing interface of the multimedia resource in a display mode corresponding to the question bullet screen information.

In step S708, the bullet screen information input interface is displayed when a control for editing bullet screen information is triggered.

In step S710, question tag information is displayed in an information input area of the bullet screen information input interface when a question control in the bullet screen information input interface is triggered, wherein the question tag information is used for indicating that the type of third bullet screen information to be input is candidate question bullet screen information.

In step S712, the third bullet screen information is sent when a control for sending bullet screen information is triggered, wherein the third bullet screen information includes a candidate question identifier, so that a server determines the type of the third bullet screen information according to the candidate question identifier.

In step S714, whether fourth bullet screen information includes an answer identifier is determined when the fourth bullet screen information is received.

In step S716, a prompt notification is sent on the playing interface of the multimedia resource when the fourth bullet screen information includes an answer identifier indicating that the fourth bullet screen information is recommended answer bullet screen information for the third bullet screen information.

The answer identifier may be an identifier that is added by the server after processing data belonging to the type of answer bullet screen information and is used for indicating that the bullet screen information is answer bullet screen information. The answer bullet screen information may refer to bullet screen information that is determined by the server and corresponding to the question bullet screen information, and may be configured for replying to the question bullet screen information. The recommended answer bullet screen information may be superior recommendable answer bullet screen information determined by the server for the question bullet screen information. The prompt notification may be configured for prompting that the fourth bullet screen information is recommended answer bullet screen information for the third bullet screen information (question bullet screen information).

For example, after the user A raises a question through a bullet screen (the terminal of the user A sends the third bullet screen information), the server receives the third bullet screen information, and determines that the type of the third bullet screen information is candidate question bullet screen information according to the candidate question identifier included in the third bullet screen information. The server may determine the third bullet screen information sent by the user A as question bullet screen information. For example, if the question content of the third bullet screen information is meaningful, the third bullet screen information may be determined as question bullet screen information by manual screening.

In this case, the server may determine answer bullet screen information for the question bullet screen information in many manners. For example, the answer bullet screen information may be answer bullet screen information corresponding to the third bullet screen information which is sent to the server by another user playing the multimedia resource who replies to the third bullet screen information after seeing the third bullet screen information sent by the user A. The answer bullet screen information may also be answer bullet screen information for the question bullet screen information which is acquired by the server from various platforms. The server may determine recommended answer bullet screen information from multiple pieces of answer bullet screen information for the question bullet screen information. The server may add an answer identifier to the recommended answer bullet screen information, wherein the answer identifier may be used for indicating that the piece of bullet screen information is answer bullet screen information and is recommended answer bullet screen information.

When receiving fourth bullet screen information, the terminal of the user A may determine whether the fourth bullet screen information includes the answer identifier, and sends a prompt notification on the playing interface of the multimedia resource when the fourth bullet screen information includes an answer identifier indicating that the fourth bullet screen information is recommended answer bullet screen information for the third bullet screen information. For example, “Your question has been answered!” may be displayed in a certain area, such as a non-ordinary bullet screen display area, on the playing interface of the multimedia resource. When the user clicks the prompt notification, the recommended answer bullet screen information may be highlighted on the playing interface of the multimedia resource. Alternatively, the recommended answer bullet screen information may be displayed on the playing interface of the multimedia resource directly, and the recommended answer bullet screen information is displayed in various highlighted display modes (for example, display in bold, fixed display for a relatively long time, flickering display, and other display modes) to send the prompt notification. The form and content of the prompt notification are not limited in this disclosure.

The terminal of the user A may send the prompt notification on the playing interface of the multimedia resource at any possible time point when receiving the fourth bullet screen information and determining the fourth bullet screen information as recommended answer bullet screen information. For example, the user A sends third bullet screen information (which is, for example, candidate question bullet screen information) at the fifth minute of the first episode of the drama series. The server determines the third bullet screen information as question bullet screen information and sends the third bullet screen information to a terminal of a user on which the first episode of the drama series is played to the corresponding time point. The server may quickly determine recommended answer bullet screen information for the third bullet screen information. For example, at this point, the user A is watching the eighth minute of the first episode of the drama series. The server may send the recommended answer bullet screen information to the terminal of the user A (at this point, the terminal of the user A receives fourth bullet screen information, and determines the fourth bullet screen information as recommended answer bullet screen information). The terminal of the user A may send a prompt notification on the playing interface of the multimedia resource.

In an example implementation, the server may determine recommended answer bullet screen information for the third bullet screen information in a period of time after the user A sends the third bullet screen information. In this case, the server may send the recommended answer bullet screen information to the terminal of the user A when the user A plays the drama series again, for example, when the user A plays the third episode of the drama series several days later. The terminal of the user A may send a prompt notification on the playing interface of the third episode of the multimedia resource.

In this manner, the user may conveniently acquire content of a recommended answer corresponding to the question content thereof, thereby reducing the user's cost of finding an answer, and improving the effectiveness and pertinence of interaction with the multimedia resource.

Those skilled in the art should understand that the terminal may send the prompt notification in many manners. For example, as described above, while the user plays a drama series, the terminal sends the prompt notification on the playing interface of the third episode of the multimedia resource when receiving fourth bullet screen information and determining the fourth bullet screen information as recommended answer bullet screen information for the third bullet screen information. In addition, the terminal may also implement prompting by a system prompt of the terminal of the user, a prompt in a playing application of the corresponding multimedia resource, and the like. For example, after determining recommended answer bullet screen information for the third bullet screen information, the server may push the prompt notification to the terminal of the user A or the playing application of the corresponding multimedia resource on the terminal of the user A. In this case, the terminal of the user A may still send the prompt notification even if the terminal is not playing the drama series. For example, the terminal may also send the prompt notification when the user A is browsing a discussion page in the playing application, to inform the user that there is already recommended answer bullet screen information for the question thereof, and the user may choose to view the recommended answer bullet screen information. The manner of sending the prompt notification by the terminal, the prompt time, and the like are not limited in this disclosure.

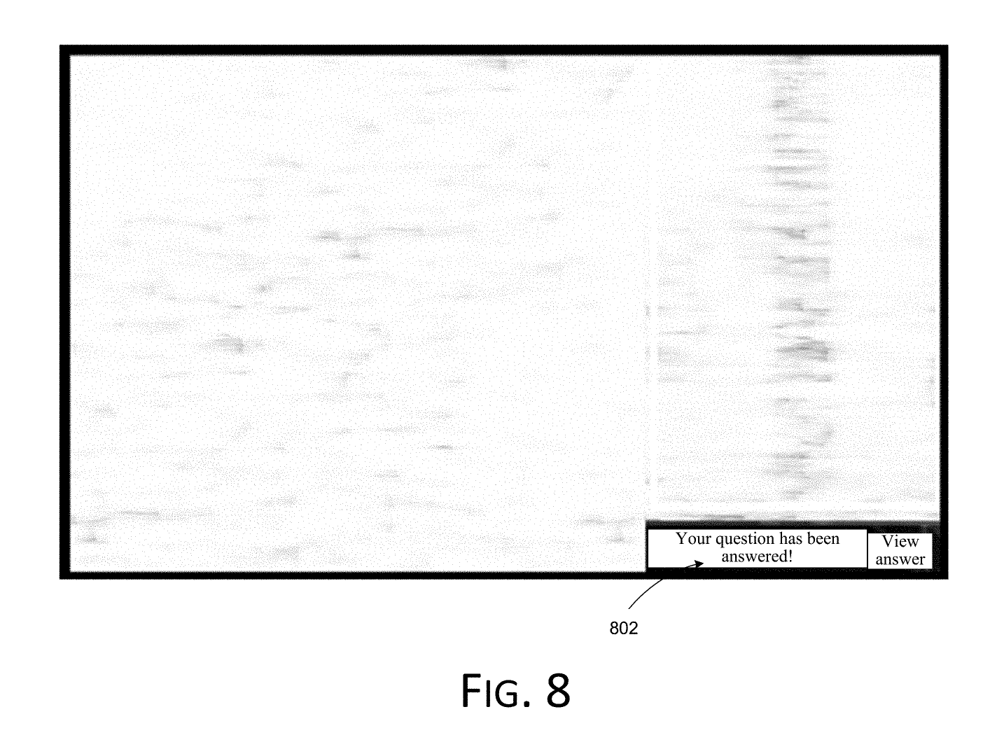

FIG. 8 is a schematic diagram of an application scenario of a bullet screen display method according to an example embodiment. In an example implementation, as shown in FIG. 8, while the user A plays the drama series, the terminal thereof determines, when receiving fourth bullet screen information, that the fourth bullet screen information includes the answer identifier indicating that the fourth bullet screen information is recommended answer bullet screen information for the third bullet screen information (the question bullet screen information sent by the user A previously). The terminal sends a prompt notification on the playing interface of the multimedia resource. As shown in FIG. 8, “Your question has been answered!” 802 is displayed in a lower left area (non-ordinary bullet screen display area) on the playing interface of the multimedia resource. The user clicks the prompt notification, and the terminal displays the recommended answer bullet screen information.

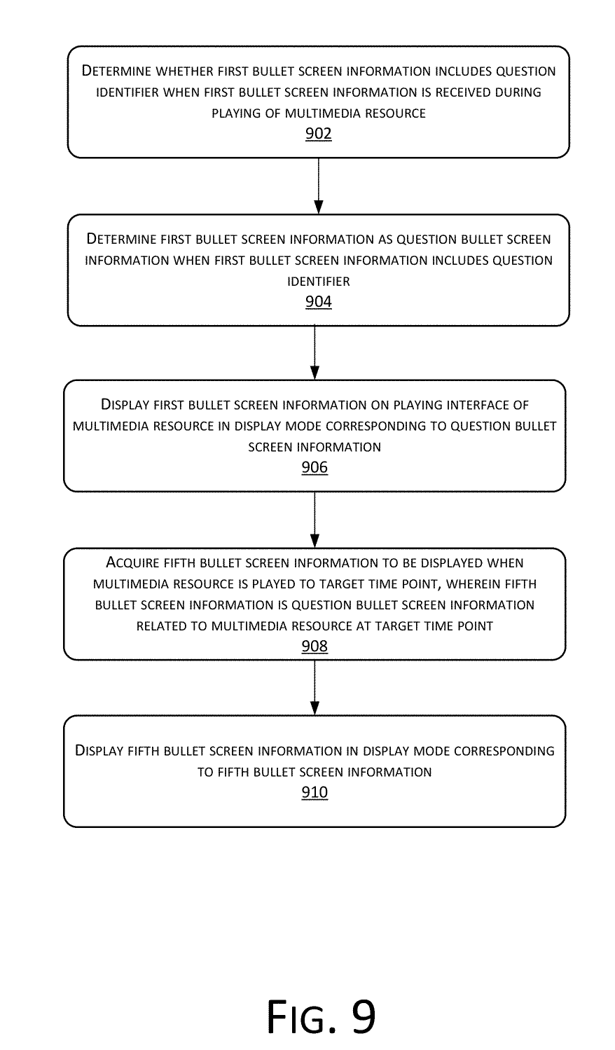

FIG. 9 is a flowchart of a bullet screen display method according to an example embodiment. In an example implementation, as shown in FIG. 9, the method further includes the following steps:

In step S902, when first bullet screen information is received during playing of a multimedia resource, whether the first bullet screen information includes a question identifier is determined.

In step S904, the first bullet screen information is determined as question bullet screen information when the first bullet screen information includes a question identifier.

In step S906, the first bullet screen information is displayed on a playing interface of the multimedia resource in a display mode corresponding to the question bullet screen information.

In step S908, fifth bullet screen information to be displayed is acquired when the multimedia resource is played to a target time point, wherein the fifth bullet screen information is question bullet screen information related to the multimedia resource at the target time point.

In step S910, the fifth bullet screen information is displayed in a display mode corresponding to the fifth bullet screen information.

The target time point may be one or more playing time points of the multimedia resource that is/are preset by the server. The fifth bullet screen information may be question bullet screen information that is preset by the server and related to the multimedia resource at the target time point. For example, the fifth bullet screen information may be question bullet screen information related to content of the drama series at the target time point, so that a question-answer scene is combined with a scene of the drama series.

For example, when playing the multimedia resource (for example, when beginning to play the multimedia resource), the terminal may acquire configuration information that is preset by the server and related to a target time point of the multimedia resource. When playing the multimedia resource to the target time point, the terminal may acquire fifth bullet screen information to be displayed. For example, the terminal may send an acquisition request for the fifth bullet screen information to the server, to acquire the fifth bullet screen information. The terminal may display the fifth bullet screen information in a display mode corresponding to the fifth bullet screen information.

The display mode corresponding to the fifth bullet screen information may include multiple forms. For example, the fifth bullet screen information may be displayed using a pop-up buoy. The buoy may include an avatar of an associated account (for example, an avatar of an account sending the question bullet screen information, and the like), question content, and a navigation button (which, for example, may be used for guiding the user to perform related operations such as viewing and answering, and may also be used for displaying the number of replies corresponding to the question bullet screen information). The content and form of the buoy, and the form and content of the navigation button are not limited in this disclosure.

In addition, the display mode corresponding to the fifth bullet screen information may be predetermined by the server, or set by default by the system of the terminal, or customized by the user. The form, content, setting manner, and the like of the display mode corresponding to the fifth bullet screen information are not limited in this disclosure.

In this manner, when playing to the target time point of the multimedia resource, the terminal displays question bullet screen information related to the multimedia resource at the target time point, thereby combining a question-answer scene with a scene of the drama series, so that the displayed question bullet screen information has high timeliness and pertinence, the user may conveniently obtain the answer to the question during playing of the multimedia resource, and interaction between the user and the multimedia resource as well as interaction between users become richer and more effective.

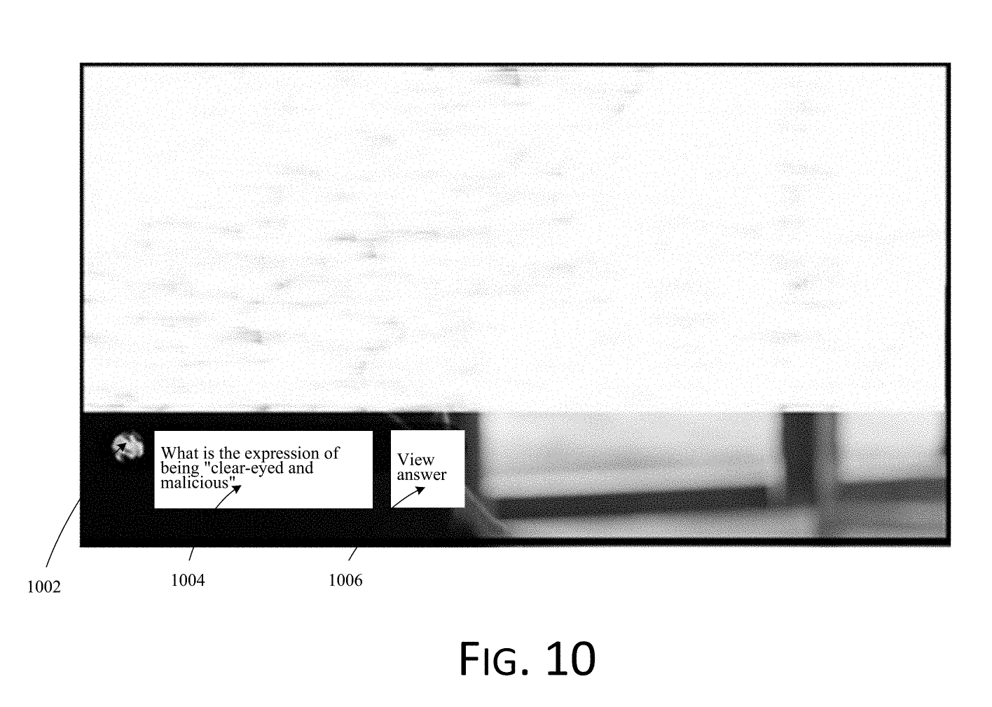

FIG. 10 is a schematic diagram of an application scenario of a bullet screen display method according to an example embodiment. In an example implementation, as shown in FIG. 10, when the user A plays a drama series in a full screen mode on the terminal thereof, for example, when the user A begins to play the drama series, the terminal may acquire configuration information that is preset by the server and related to the target time point of the multimedia resource. For example, the terminal acquires from the server that the drama series includes 2 target time points, which are a target time point 1 and a target time point 2 respectively. When the terminal plays to the target time point 1 in the full screen mode, the terminal may acquire fifth bullet screen information to be displayed, wherein the fifth bullet screen information is question bullet screen information that is preset by the server and related to content of the drama series at the target time point 1.

For example, as shown in FIG. 10, the content of the drama series at the target time point 1 is that Sima Yi looks back with a sharp glance. The question content of the fifth bullet screen information that is preset by the server and corresponding to the target time point 1 is item 1002: what is the expression of being “clear-eyed and malicious.” Then the terminal displays the fifth bullet screen information in a display mode corresponding to the fifth bullet screen information. For example, as shown in FIG. 10, a buoy pops up, wherein the buoy includes an avatar of an associated account (for example, an avatar 1002 of an account sending the question bullet screen information), question content 1004 (what is the expression of being “clear-eyed and malicious”), a navigation button 1006 (for example, a navigation button for viewing an answer), and the like

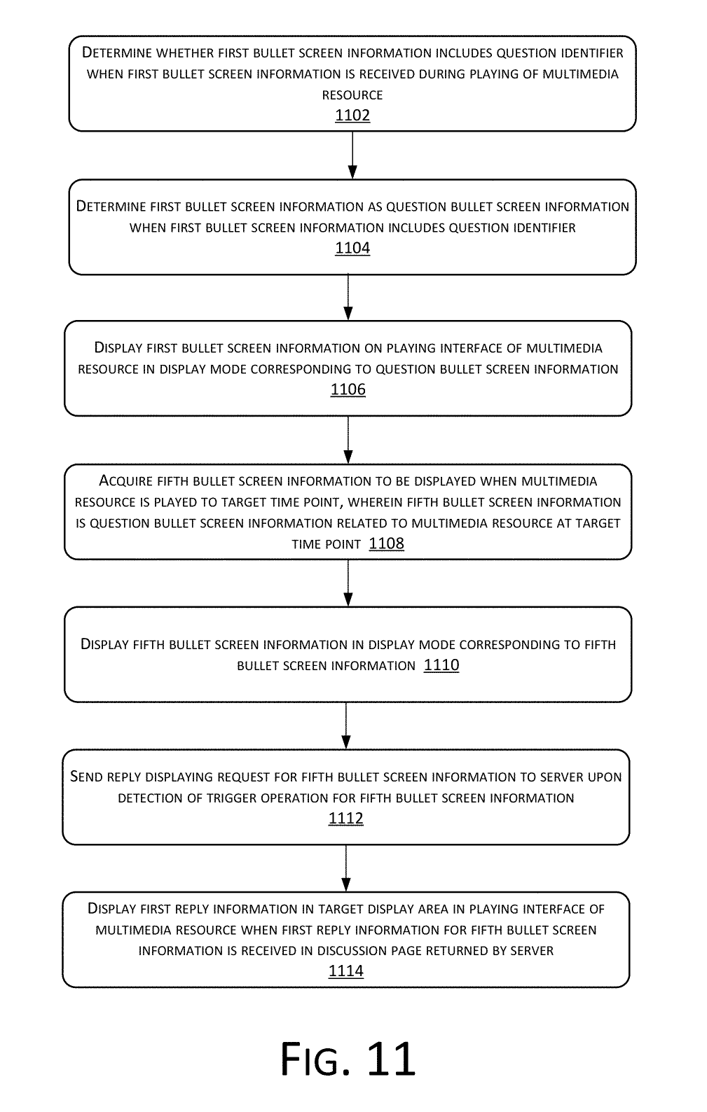

FIG. 11 is a flowchart of a bullet screen display method according to an example embodiment. In an example implementation, as shown in FIG. 11, the method further includes the following steps:

In step S1102, when first bullet screen information is received during playing of a multimedia resource, whether the first bullet screen information includes a question identifier is determined.

In step S1104, the first bullet screen information is determined as question bullet screen information when the first bullet screen information includes a question identifier.

In step S1106, the first bullet screen information is displayed on a playing interface of the multimedia resource in a display mode corresponding to the question bullet screen information.

In step S1108, fifth bullet screen information to be displayed is acquired when the multimedia resource is played to a target time point, wherein the fifth bullet screen information is question bullet screen information related to the multimedia resource at the target time point.

In step S1110, the fifth bullet screen information is displayed in a display mode corresponding to the fifth bullet screen information.

In step S1112, a reply displaying request for the fifth bullet screen information is sent to the server upon detection of a trigger operation for the fifth bullet screen information.

In step S1114, first reply information is displayed in a target display area in the playing interface of the multimedia resource when the first reply information for the fifth bullet screen information in a discussion page returned by the server is received.

The discussion page may be a page of any interactive community, for example, a page of a forum. The first reply information may include various types of reply information for the fifth bullet screen information in the discussion page. The target display area may be any display area on the playing interface of the multimedia resource, for example, a specific display area different from an ordinary bullet screen display area. For example, the target display area may be an area on the right side of the playing interface of the multimedia resource and floating above the ordinary bullet screen display area in the playing interface of the multimedia resource. The content and form of the first reply information, and specific position information of the target display area are not limited in this disclosure.

For example, if the user A wants to view reply content corresponding to the fifth bullet screen information, the user A may trigger the fifth bullet screen information. Upon detection of the trigger operation for the fifth bullet screen information, the terminal may send a reply displaying request for the fifth bullet screen information to the server. When receiving first reply information for the fifth bullet screen information in a discussion page returned by the server, the terminal may display the first reply information in the target display area in the playing interface of the multimedia resource.

In this manner, the user may obtain reply information corresponding to the question content without pausing or exiting the playing interface of the multimedia resource, while smooth playing of the multimedia resource and transfer of knowledge in questions and answers are ensured.

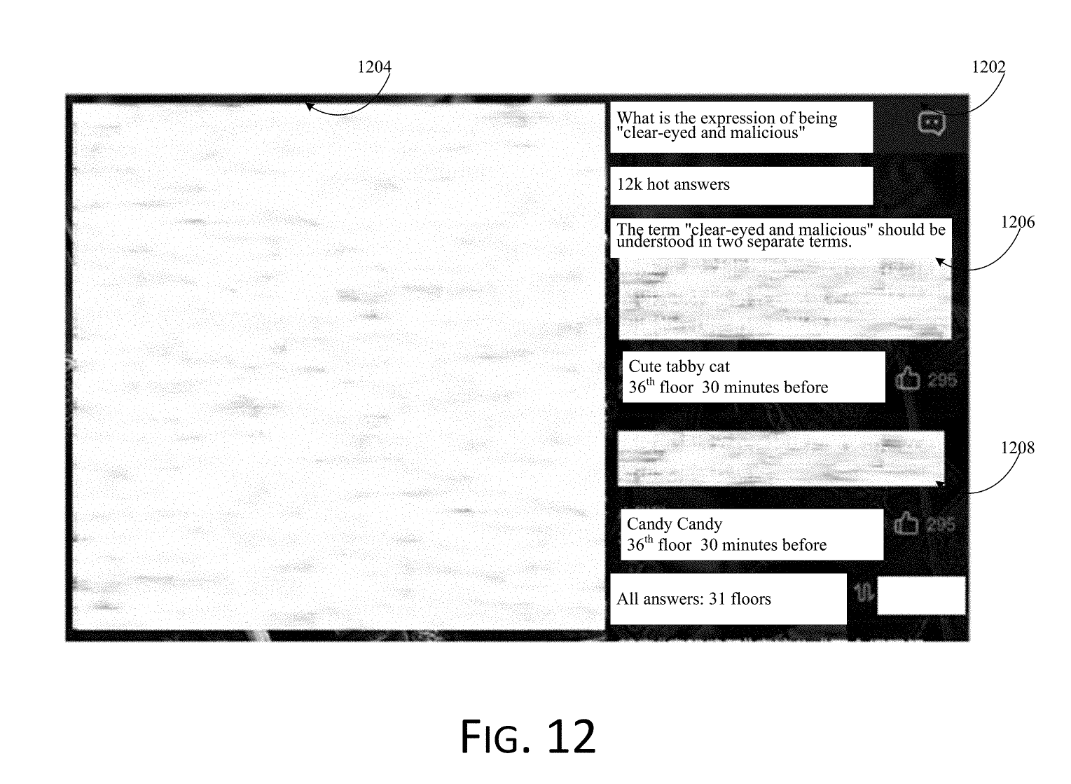

FIG. 12 is a schematic diagram of an application scenario of a bullet screen display method according to an example embodiment. In an example implementation, as shown in FIG. 12, after the user A clicks the fifth bullet screen information in FIG. 10, the terminal sends the reply displaying request for the fifth bullet screen information to the server upon detection of the trigger operation for the fifth bullet screen information. When receiving first reply information for the fifth bullet screen information in the discussion page returned by the server, the terminal displays the first reply information in the target display area in the playing interface of the multimedia resource. For example, as shown in FIG. 12, a forum page such as an HTML5 forum page 1202 is opened on the right portion screen of the terminal, so that the user A may watch the drama series on the left portion screen 1204 of the terminal while browsing the first reply information. There may be many first replay information, such as a first piece of first replay information 1206 which is answered by a user called Cute tabby cat and a second piece of first reply information 1208 which is posted by a user called Candy Candy. The user A may perform related operations on the first reply information, for example, give a like to a favorite piece of first reply information, reply to the first reply information, select an arrangement order of the first reply information, which are not limited in this disclosure.

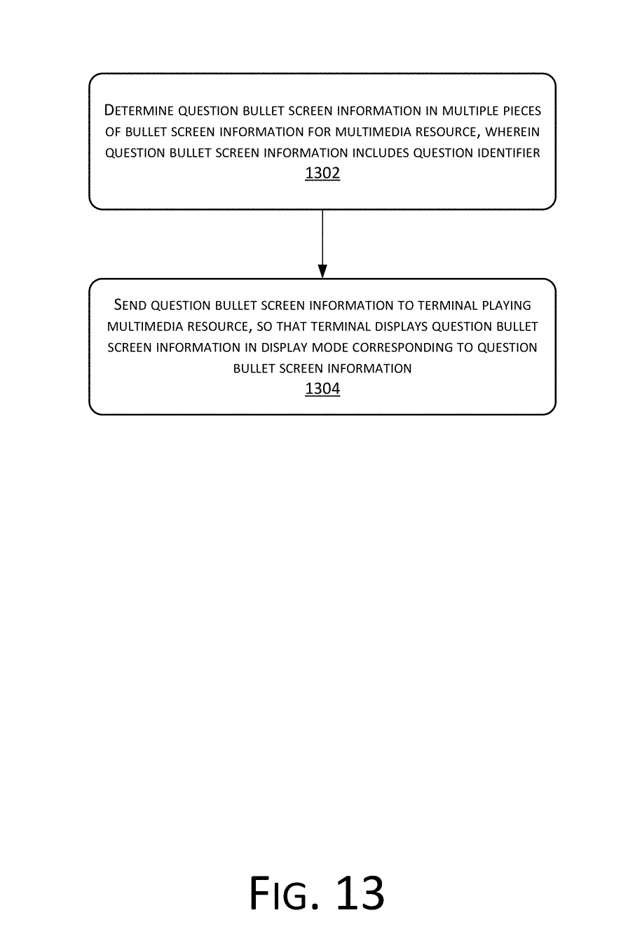

FIG. 13 is a flowchart of a bullet screen display method according to an example embodiment. The method is applicable in a server. As shown in FIG. 13, the bullet screen display method according to the embodiment of this disclosure includes the following steps:

In step S1302, question bullet screen information in multiple pieces of bullet screen information for a multimedia resource is determined, wherein the question bullet screen information includes a question identifier.

In step S1304, the question bullet screen information is sent to a terminal playing the multimedia resource, so that the terminal displays the question bullet screen information in a display mode corresponding to the question bullet screen information.

According to the embodiment of this disclosure, question bullet screen information in multiple pieces of bullet screen information for a multimedia resource may be determined, wherein the question bullet screen information includes a question identifier; and the question bullet screen information is sent to a terminal playing the multimedia resource, so that the terminal displays the question bullet screen information in a display mode corresponding to the question bullet screen information. As such, the server may determine the question bullet screen information in the multiple pieces of bullet screen information for the multimedia resource, and sends the question bullet screen information to the terminal playing the multimedia resource, so that the terminal displays the question bullet screen information in the display mode corresponding to the question bullet screen information, thereby enriching types and display modes of bullet screen information, and also enriching modes of interaction between a user and the multimedia resource and interaction between users.

For example, the server may determine, in many manners, the question bullet screen information in the multiple pieces of bullet screen information for the multimedia resource. For example, as described above, the user A sends third bullet screen information through the terminal thereof, wherein the third bullet screen information includes the candidate question identifier. When receiving the third bullet screen information, the server may determine whether the third bullet screen information includes the candidate question identifier, and may determine that the type of the third bullet screen information is the candidate question bullet screen information when determining that the third bullet screen information includes the candidate question identifier. The server may determine the third bullet screen information as one piece of question bullet screen information for the multimedia resource. For example, if it is determined after manual screening that the third bullet screen information has good content, the server may determine the third bullet screen information as one piece of question bullet screen information for the multimedia resource.

In an example implementation, the server may determine the question bullet screen information in the multiple pieces of bullet screen information for the multimedia resource by processing the bullet screen information for the multimedia resource.

For example, as described above, the server receives the third bullet screen information sent by the terminal of the user A, and determines that the type of the third bullet screen information is the candidate question bullet screen information and that the third bullet screen information is a piece of bullet screen information for the multimedia resource. The server may audit and process the third bullet screen information. For example, the server transforms the sentence pattern of the third bullet screen information (for example, adjustment between the active and passive forms), recognizes and corrects typos, and performs various other processing. The server may determine the processed bullet screen information as question bullet screen information.

In this manner, the server may certainly obtain question bullet screen information that may be understood by users easily and has the standard form and content. Those skilled in the art should understand that the bullet screen information for the multimedia resource may be processed before or after the question bullet screen information is determined. For example, the third bullet screen information is determined as question bullet screen information through manual screening, and the question bullet screen information is processed to obtain the final question bullet screen information. The processing manner and processing sequence are not limited in this disclosure.

In an example implementation, the server determines question bullet screen information in multiple pieces of bullet screen information for a multimedia resource, and the server may perform data processing on the question bullet screen information and add a question identifier. As such, the server may determine the question bullet screen information in the multiple pieces of bullet screen information for the multimedia resource, wherein the bullet screen information includes the question identifier. The manner in which the server determines the question bullet screen information in the multiple pieces of bullet screen information for the multimedia resource, the manner of adding the question identifier, the form of the question identifier, and the like are not limited in this disclosure.

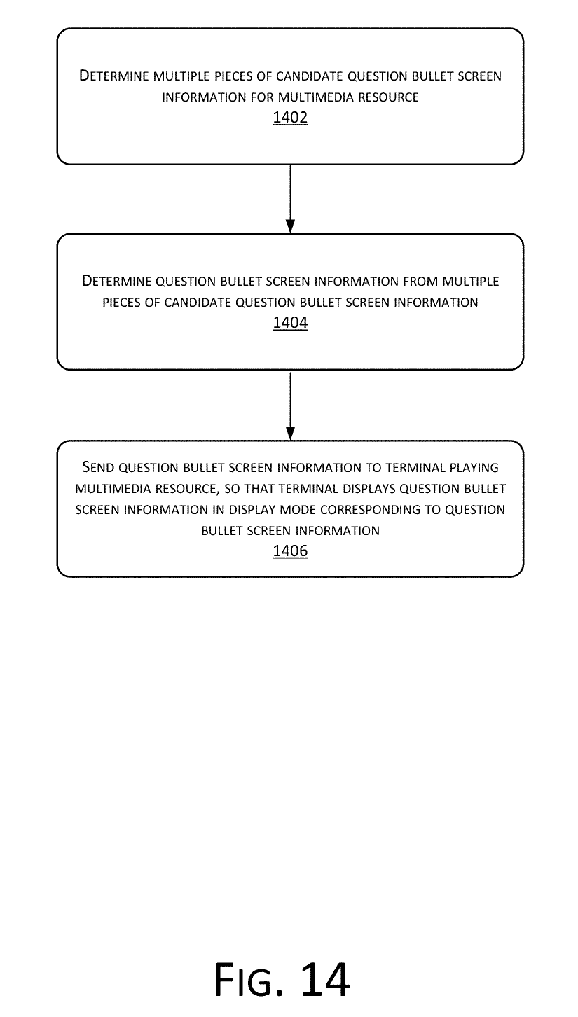

FIG. 14 is a flowchart of a bullet screen display method according to an example embodiment. In an example implementation, as shown in FIG. 14, step S1302 may include the following steps:

In step S1402, multiple pieces of candidate question bullet screen information for the multimedia resource are determined.

For example, the server may determine multiple pieces of candidate question bullet screen information for the multimedia resource. For example, as described above, if a piece of bullet screen information received by the server includes a candidate question identifier, the server may determine the bullet screen information as candidate question bullet screen information.

In an example implementation, step S1402 of determining multiple pieces of candidate question bullet screen information for the multimedia resource may further include:

determining bullet screen information including a question keyword as the candidate question bullet screen information.

The question keyword may be phrases for representing a question. For example, the question keyword may include “what is,” “what is called,” “why,” “what's” and so on. The specific content of the question keyword is not limited in this disclosure.

For example, the server may perform data processing on the acquired multiple pieces of bullet screen information for the multimedia resource. For example, the server may filter the multiple pieces of bullet screen information to obtain bullet screen information including a question keyword, and determine the bullet screen information including the question keyword as the candidate question bullet screen information.

In this manner, the server may determine multiple pieces of candidate question bullet screen information for the multimedia resource by filtering question keywords.

In step S1404, the question bullet screen information is determined from the multiple pieces of candidate question bullet screen information.

For example, the server may determine multiple pieces of candidate question bullet screen information in many manners. The server may determine the question bullet screen information from the multiple pieces of candidate question bullet screen information. For example, through manual screening, candidate question bullet screen information with good content and meaning in the multiple pieces of candidate question bullet screen information is determined as the question bullet screen information.

In this manner, the server may determine the question bullet screen information in the multiple pieces of bullet screen information for the multimedia resource. Those skilled in the art should understand that the server may determine the question bullet screen information in the multiple pieces of bullet screen information for the multimedia resource in many manners. For example, as described above, the server determines multiple pieces of candidate question bullet screen information, and determines the question bullet screen information from the multiple pieces of candidate question bullet screen information (for example, the server processes the candidate question bullet screen information and determines the question bullet screen information). The server may further add a function of importing related data of the question bullet screen information. For example, multiple pieces of bullet screen information for the multimedia resource may be determined according to meaningful question topics for the multimedia resource (for example, multiple pieces of bullet screen information are determined for question topics manually), one or more pieces of question bullet screen information are determined from the multiple pieces of bullet screen information, and a question identifier is added to the question bullet screen information. The server may import related data of the question bullet screen information (for example, import text-format related data of the question bullet screen information). The manner in which the server determines question bullet screen information in the multiple pieces of bullet screen information for the multimedia resource is not limited in this disclosure.

As shown in FIG. 14, in step S1406, the question bullet screen information is sent to the terminal playing the multimedia resource, so that the terminal displays the question bullet screen information in a display mode corresponding to the question bullet screen information

For example, the user A plays the multimedia resource on his/her terminal. The server may send the question bullet screen information to the terminal according to a playing progress of the multimedia resource on the terminal, so that the terminal displays the question bullet screen information in a display mode corresponding to the question bullet screen information. This process has been described above, and details are not described here again.

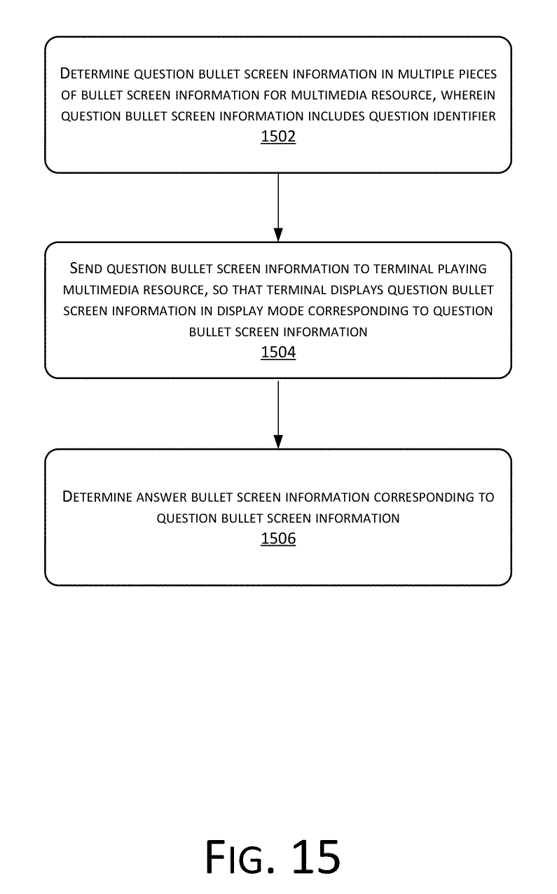

FIG. 15 is a flowchart of a bullet screen display method according to an example embodiment. In an example implementation, as shown in FIG. 15, the method may further include the following step:

In step S1502, question bullet screen information in multiple pieces of bullet screen information for a multimedia resource is determined, wherein the question bullet screen information includes a question identifier.

In step S1504, the question bullet screen information is sent to a terminal playing the multimedia resource, so that the terminal displays the question bullet screen information in a display mode corresponding to the question bullet screen information.

In step S1506, answer bullet screen information corresponding to the question bullet screen information is determined, wherein the answer bullet screen information includes an answer identifier used for indicating that the answer bullet screen information is answer bullet screen information corresponding to the question bullet screen information.

For example, the server may determine answer bullet screen information corresponding to the question bullet screen information. The server may perform data processing on the answer bullet screen information, and add an answer identifier. The answer identifier may be used for indicating that the answer bullet screen information is answer bullet screen information corresponding to the question bullet screen information.

In this manner, the server may determine the answer bullet screen information corresponding to the question bullet screen information, where the answer bullet screen information includes the answer identifier. The manner of determining the answer bullet screen information corresponding to the question bullet screen information by the server, the manner of adding the answer identifier, the form of the answer identifier, and the like are not limited in this disclosure.

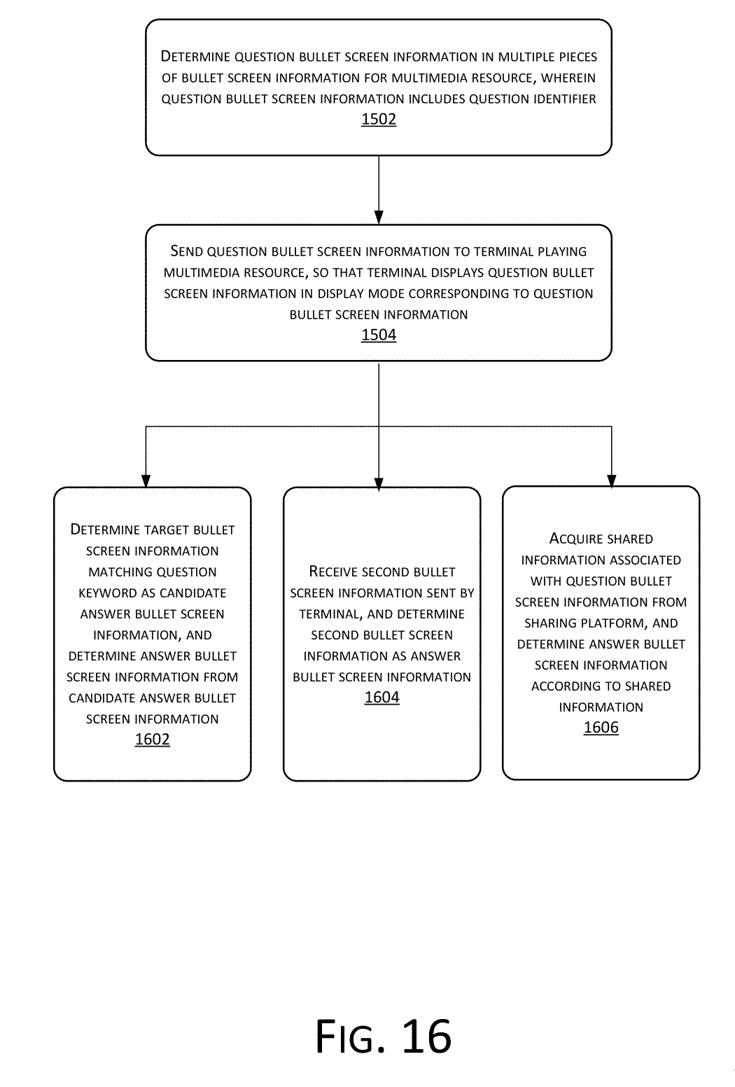

FIG. 16 is a flowchart of a bullet screen display method according to an example embodiment. In an example implementation, as shown in FIG. 16, there are following steps.

In step S1502, question bullet screen information in multiple pieces of bullet screen information for a multimedia resource is determined, wherein the question bullet screen information includes a question identifier.

In step S1504, the question bullet screen information is sent to a terminal playing the multimedia resource, so that the terminal displays the question bullet screen information in a display mode corresponding to the question bullet screen information.

In FIG. 16, the step S1506 may include at least one of the following sub-steps:

In step S1602, target bullet screen information matching a question keyword is determined as candidate answer bullet screen information, and the answer bullet screen information is determined from the candidate answer bullet screen information, wherein the target bullet screen information is bullet screen information that is received by the server in a target time interval after the question bullet screen information is displayed.

The question keyword may be a key term included in the question bullet screen information. For example, question content of the question bullet screen information is “What does Sikong mean at that time”, the key term “Sikong” may be determined as the question keyword. The manner of determining the question keyword, the form of the question keyword, and the number of the keywords are not limited in this disclosure.

For example, the server may send question bullet screen information to multiple terminals playing the multimedia resource. The server may obtain bullet screen information that is received in a target time interval (for example, in 60 seconds) after the question bullet screen information is displayed.

For example, the server sends a piece of question bullet screen information to multiple terminals playing the multimedia resource at 20:00, and may determine bullet screen information received between 20:00 and 20:01 as target bullet screen information. The server may determine target bullet screen information matching the question keyword as candidate answer bullet screen information, and determine the answer bullet screen information from the candidate answer bullet screen information. For example, the server receives several pieces of bullet screen information in the 60 seconds, and these pieces of bullet screen information are target bullet screen information. The server may determine target bullet screen information including “Sikong” as candidate answer bullet screen information, and determine the answer bullet screen information from the candidate answer bullet screen information through manual screening. It should be noted that if there are multiple question keywords, a rule for matching with the question keywords may be set. For example, it may be set that bullet screen information including any of the multiple question keywords may be considered as matching the question keywords. It may also be set that bullet screen information including all question keywords may be considered as matching the question keywords. The duration of the target time interval, the rule for matching with the question keyword, and the specific manner of determining the answer bullet screen information are not limited in this disclosure.

In step S1604, second bullet screen information sent by the terminal is received, and the second bullet screen information is determined as the answer bullet screen information, wherein the second bullet screen information includes the question identifier of the question bullet screen information.

For example, as described above, the user A replies, through the terminal thereof, to the first bullet screen information (the question bullet screen information) from the user B, and sends second bullet screen information through the terminal thereof. The second bullet screen information includes the question identifier of the first bullet screen information. In this case, when receiving the second bullet screen information, the server may determine the second bullet screen information as the answer bullet screen information according to the question identifier of the first bullet screen information included therein.

In step S1606, shared information associated with the question bullet screen information is acquired from a sharing platform, and the answer bullet screen information is determined according to the shared information.

For example, the server may further acquire shared information associated with the question bullet screen information from a sharing platform, and determine the answer bullet screen information according to the shared information. For example, when there is no suitable answer bullet screen information, the server may acquire shared information associated with the question bullet screen information from various types of sharing platforms, and determine the answer bullet screen information according to the shared information. As described above, the server may further add a function of importing related data of the question bullet screen information. The server may determine the answer bullet screen information according to the shared information acquired from the sharing platform, import the answer bullet screen information, and determine the answer bullet screen information as answer data corresponding to the question bullet screen information. The server may output the related data of the question bullet screen information (for example, including the question bullet screen information and its question identifier, the answer bullet screen information corresponding to the question bullet screen information and its answer identifier) to an interface of the terminal, so that the terminal displays the related data.

As such, the answer bullet screen information corresponding to the question bullet screen information may be determined in many manners. The specific manner of determining the answer bullet screen information corresponding to the question bullet screen information is not limited in this disclosure.

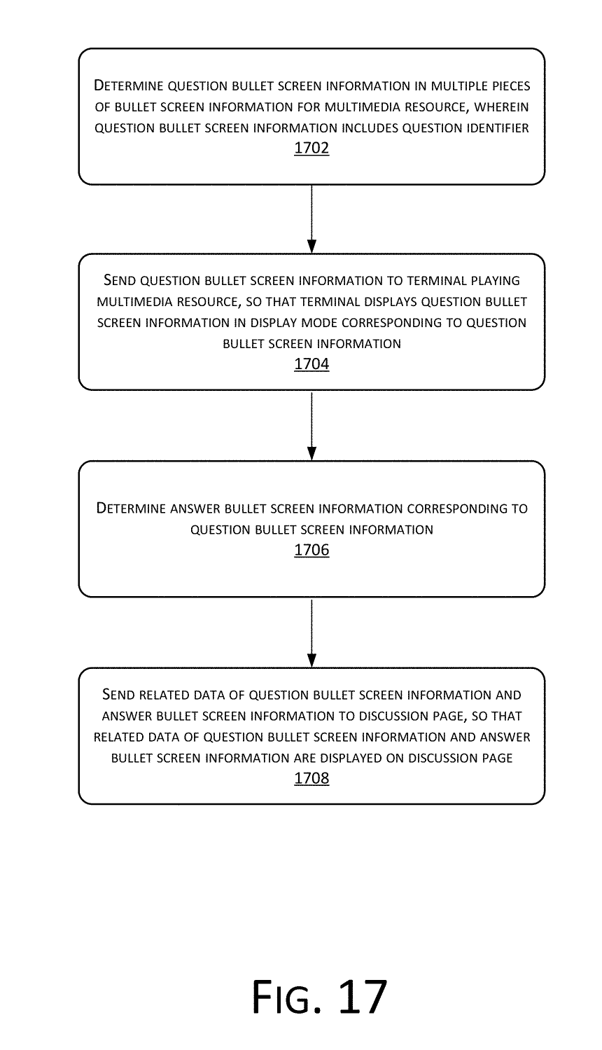

FIG. 17 is a flowchart of a bullet screen display method according to an example embodiment. In an example implementation, as shown in FIG. 17, the method may further include the following steps:

In step S1702, question bullet screen information in multiple pieces of bullet screen information for a multimedia resource is determined, wherein the question bullet screen information includes a question identifier.

In step S1704, the question bullet screen information is sent to a terminal playing the multimedia resource, so that the terminal displays the question bullet screen information in a display mode corresponding to the question bullet screen information.

In step S1706, answer bullet screen information corresponding to the question bullet screen information is determined, wherein the answer bullet screen information includes an answer identifier used for indicating that the answer bullet screen information is answer bullet screen information corresponding to the question bullet screen information.

In step S1708, related data of the question bullet screen information and the answer bullet screen information are sent to a discussion page, so that the related data of the question bullet screen information and the answer bullet screen information are displayed on the discussion page.

For example, the server may send related data of the question bullet screen information and the answer bullet screen information to a discussion page, so that the related data of the question bullet screen information and the answer bullet screen information is displayed on the discussion page. For example, the server may send data of the question bullet screen information and data of the answer bullet screen information corresponding to the question bullet screen information to the discussion page. For example, the related data may be synchronized to an interactive community.

In an example implementation, the server determines multiple pieces of question bullet screen information, and in this case, each piece of question bullet screen information may correspond to one discussion page (for example, a post) of the interactive community. A manner of displaying the related data of the question bullet screen information and the answer bullet screen information on the discussion page is illustrated by taking one discussion page as an example.

For example, the title of the discussion page may be the question bullet screen information (for example, what is the expression of “clear-eyed and malicious”). The main body of the discussion page may be the question bullet screen information and a playing time point of the multimedia resource corresponding to the question bullet screen information. An initiation account of the discussion page may be an account sending the question bullet screen information. An initiation time of the discussion page may be time when the question bullet screen information is sent. The discussion page may include multiple replies, and reply content may be answer bullet screen information. A replying account may be an account sending the answer bullet screen information. A reply time maybe time when the answer bullet screen information is sent, etc.

In an example implementation, the discussion page may be updated at a fixed cycle, for example, updated once a day.

In this manner, related data of the question bullet screen information and the answer bullet screen information may be sent to the discussion page, so that the related data of the question bullet screen information and the answer bullet screen information is displayed on the discussion page. Related data of high-quality, strong-timeliness, user-friendly question bullet screen information and the answer bullet screen information is sent to the interactive community, so that users may interact in many manners, thereby enriching interaction modes.

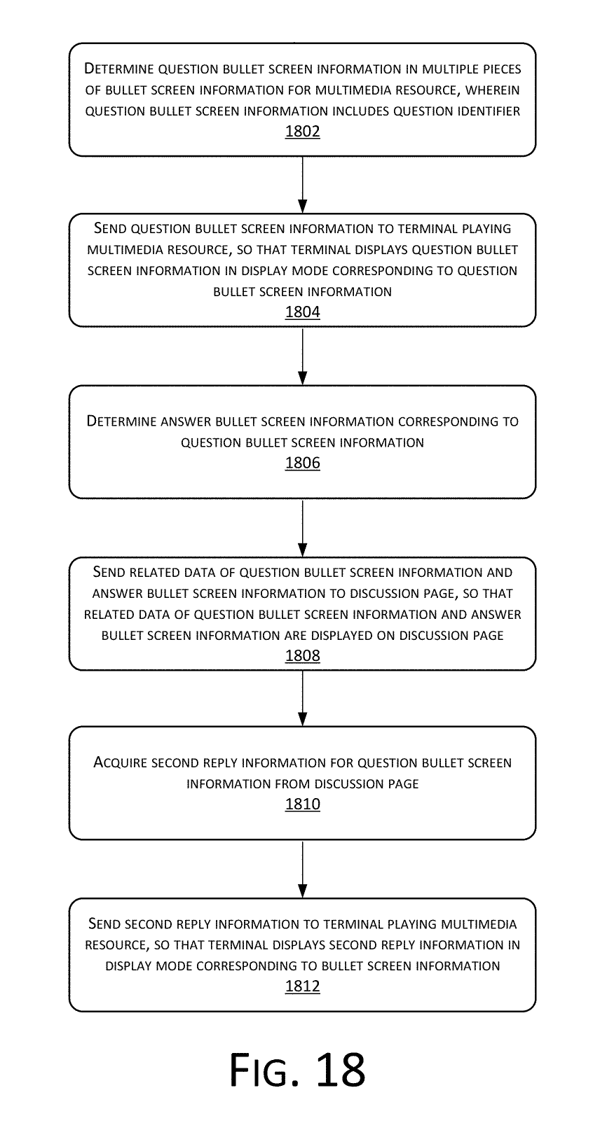

FIG. 18 is a flowchart of a bullet screen display method according to an example embodiment. In an example implementation, as shown in FIG. 18, the method may further include the following steps:

In step S1802, question bullet screen information in multiple pieces of bullet screen information for a multimedia resource is determined, wherein the question bullet screen information includes a question identifier.

In step S1804, the question bullet screen information is sent to a terminal playing the multimedia resource, so that the terminal displays the question bullet screen information in a display mode corresponding to the question bullet screen information.

In step S1806, answer bullet screen information corresponding to the question bullet screen information is determined, wherein the answer bullet screen information includes an answer identifier used for indicating that the answer bullet screen information is answer bullet screen information corresponding to the question bullet screen information.

In step S1808, related data of the question bullet screen information and the answer bullet screen information are sent to a discussion page, so that the related data of the question bullet screen information and the answer bullet screen information are displayed on the discussion page.

In step S1810, second reply information for the question bullet screen information is acquired from the discussion page.

In step S1812, the second reply information is sent to the terminal playing the multimedia resource, so that the terminal displays the second reply information in a display mode corresponding to bullet screen information.

The second reply information may include reply content for the question bullet screen information provided by various users in the discussion page.

For example, the server sends related data of the question bullet screen information and the answer bullet screen information to the discussion page, and as described above, the related data of the question bullet screen information and the answer bullet screen information is displayed on the discussion page. Users may interact through the discussion page. For example, a user C may not watch the drama series, but replies after browsing the discussion page. The server may acquire second reply information for the question bullet screen information provided by the user C in the discussion page. The server may send the second reply information to a terminal playing the multimedia resource, so that the terminal displays the second reply information in a display mode corresponding to bullet screen information.

For example, a user D watches the drama series and enables a bullet screen function. The terminal of the user D displays a piece of question bullet screen information and answer bullet screen information corresponding to the question bullet screen information. In addition, when receiving second reply information (which is a reply provided by the user C in the discussion page for the question bullet screen information, for example, reply content in the discussion page) sent by the server, the terminal of the user D displays the second reply information in a display mode corresponding to bullet screen information. For example, the second reply information may move across the bullet screen information display area like ordinary bullet screen information. The display mode corresponding to bullet screen information is not limited in this disclosure.

This manner may enrich modes of interaction with the multimedia resource and facilitate user operations.

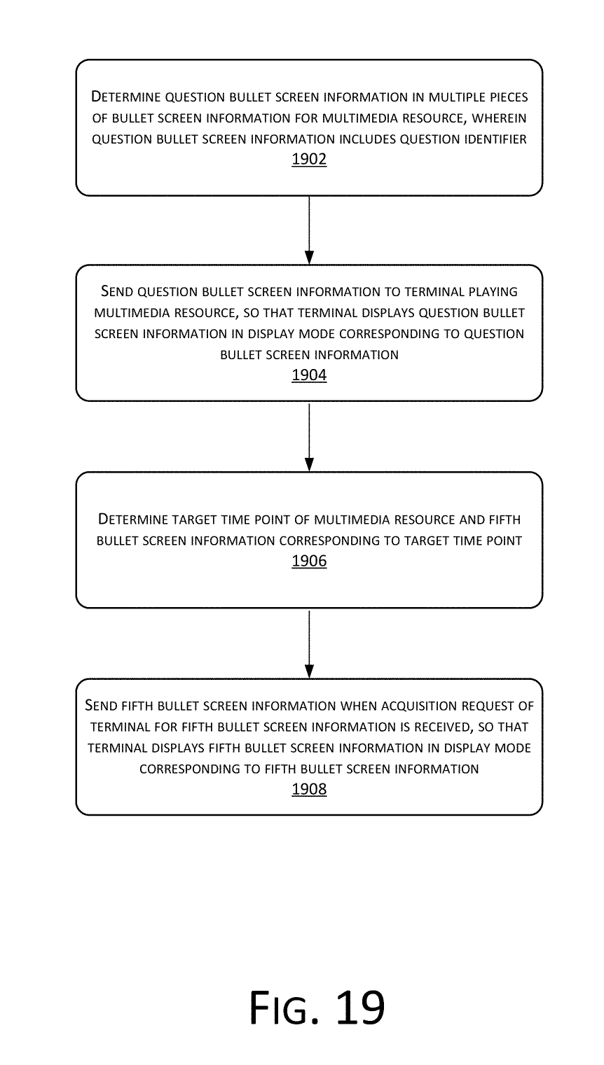

FIG. 19 is a flowchart of a bullet screen display method according to an example embodiment. In an example implementation, as shown in FIG. 19, the method may further include the following steps:

In step S1902, question bullet screen information in multiple pieces of bullet screen information for a multimedia resource is determined, wherein the question bullet screen information includes a question identifier.

In step S1904, the question bullet screen information is sent to a terminal playing the multimedia resource, so that the terminal displays the question bullet screen information in a display mode corresponding to the question bullet screen information.

In step S1906, a target time point of the multimedia resource and fifth bullet screen information corresponding to the target time point are determined.

In step S1908, the fifth bullet screen information is sent when an acquisition request of the terminal for the fifth bullet screen information is received, so that the terminal displays the fifth bullet screen information in a display mode corresponding to the fifth bullet screen information.

For example, the server may determine a target time point of the multimedia resource and fifth bullet screen information corresponding to the target time point. For example, the server may determine multiple pieces of question bullet screen information. For example, if one piece of question bullet screen information is close to content of the multimedia resource at a certain playing time point, the server may determine the playing time point as a target time point, and determine the question bullet screen information close to the content at the playing time point as the fifth bullet screen information corresponding to the target time point.

When receiving an acquisition request of the terminal for the fifth bullet screen information, the server may send the fifth bullet screen information, so that the terminal displays the fifth bullet screen information in a display mode corresponding to the fifth bullet screen information. This process has been described above, and details are not described here again.

In this manner, the server may determine a target time point of the multimedia resource and fifth bullet screen information corresponding to the target time point, and send the fifth bullet screen information when receiving an acquisition request of the terminal for the fifth bullet screen information, so that the terminal displays the fifth bullet screen information in a display mode corresponding to the fifth bullet screen information. Therefore, a question-answer scene may be combined with a scene of the drama series, so that the question bullet screen information displayed by the terminal has high timeliness and pertinence, the user may conveniently obtain the answer to the question during playing of the multimedia resource, and interaction between the user and the multimedia resource as well as interaction between users become richer and more effective. The number of the target time points, the number of pieces of the fifth bullet screen information, the form of the fifth bullet screen information, and the like are not limited in this disclosure.

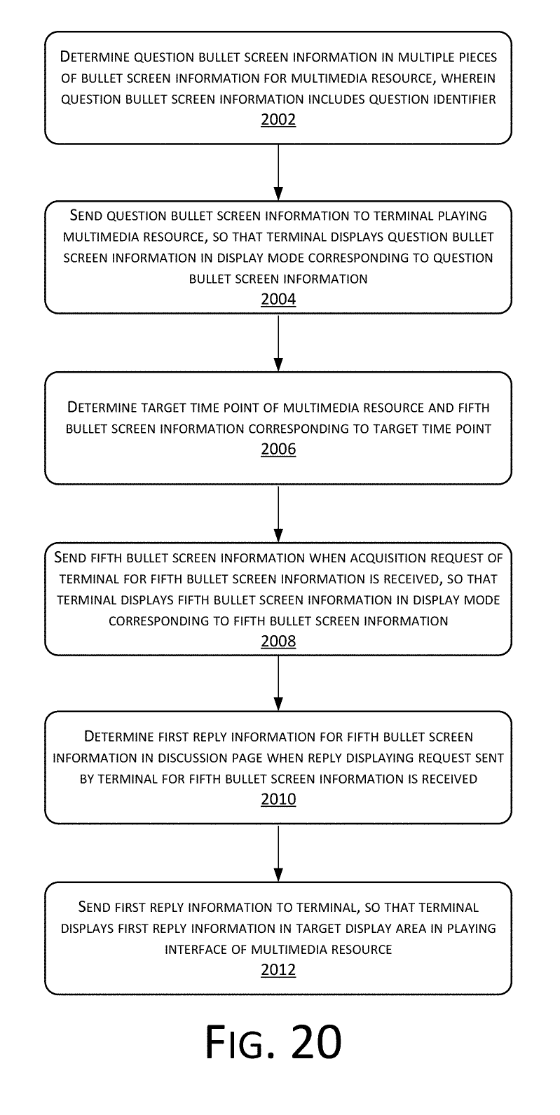

FIG. 20 is a flowchart of a bullet screen display method according to an example embodiment. In an example implementation, as shown in FIG. 20, the method may further include the following steps:

In step S2002, question bullet screen information in multiple pieces of bullet screen information for a multimedia resource is determined, wherein the question bullet screen information includes a question identifier.

In step S2004, the question bullet screen information is sent to a terminal playing the multimedia resource, so that the terminal displays the question bullet screen information in a display mode corresponding to the question bullet screen information.

In step S2006, a target time point of the multimedia resource and fifth bullet screen information corresponding to the target time point are determined.

In step S2008, the fifth bullet screen information is sent when an acquisition request of the terminal for the fifth bullet screen information is received, so that the terminal displays the fifth bullet screen information in a display mode corresponding to the fifth bullet screen information.

In step S2010, first reply information for the fifth bullet screen information in a discussion page is determined when a reply displaying request sent by the terminal for the fifth bullet screen information is received.

In step S2012, the first reply information is sent to the terminal, so that the terminal displays the first reply information in a target display area in the playing interface of the multimedia resource.

For example, when receiving a reply displaying request sent by the terminal for the fifth bullet screen information, the server may determine first reply information for the fifth bullet screen information in a discussion page. As described above, the first reply information may be answer bullet screen information corresponding to the fifth bullet screen information determined by the server. The first reply information may include the answer bullet screen information corresponding to the fifth bullet screen information determined by the server, and may also include second reply information with which a user replies to the fifth bullet screen information in the discussion page. The form and content of the first reply information are not limited in this disclosure.

The server may send the first reply information to the terminal, so that the terminal displays the first reply information in a target display area in the playing interface of the multimedia resource. This process has been described above, and details are not described here again.

In this manner, the user may obtain reply information corresponding to the question content without pausing or exiting the playing interface of the multimedia resource, while smooth playing of the multimedia resource and transfer of knowledge in questions and answers are ensured.

### APPLICATION EXAMPLES

An application example according to the embodiments of this disclosure is provided by taking “a user A watching drama series 1” as an example application scenario, to facilitate understanding of the process of the bullet screen display method. Those skilled in the art should understand that the following application example is merely for the purpose of facilitating understanding of the embodiments of this disclosure, and should not be construed as a limitation on the embodiments of this disclosure.

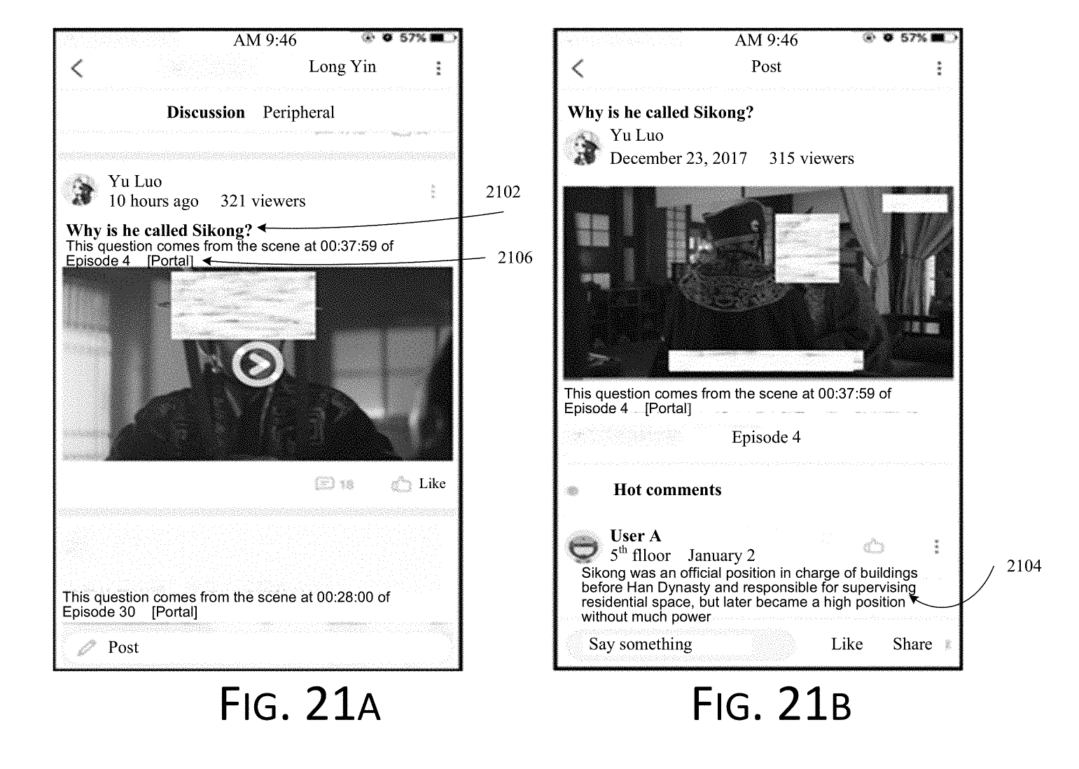

FIG. 21a and FIG. 21b are each a schematic diagram of an application scenario of a bullet screen display method according to an example embodiment. In the application example, a server determines question bullet screen information in multiple pieces of bullet screen information for the drama series 1, and adds a corresponding question identifier to the question bullet screen information. For example, the server determines multiple pieces of question bullet screen information, wherein one piece of question bullet screen information is question bullet screen information 1 sent by a user previously and having question content 2102 such as “Why is he called Sikong?”.

In the application example, the user A watches the drama series 1. During playing of the drama series 1, the server sends bullet screen information to the terminal of the user A, wherein one piece of bullet screen information is the question bullet screen information 1. When receiving first bullet screen information, the terminal of the user A determines whether the first bullet screen information includes a question identifier. If the first bullet screen information does not include a question identifier, it is determined as ordinary bullet screen information, and the terminal may display the first bullet screen information in a display mode corresponding to ordinary bullet screen information. For example, text content of the bullet screen information moves through a playing interface.

In the application example, when the first bullet screen information received by the terminal includes a question identifier, the terminal determines the first bullet screen information as question bullet screen information and displays the first bullet screen information on the playing interface of the drama series 1 in a display mode corresponding to the question bullet screen information. For example, a question icon (such as a question mark) is added in front of the first bullet screen information, and an answer button is added behind the first bullet screen information.

In the application example, the user A is interested in answering the first bullet screen information (the question bullet screen information). The user A may trigger the first bullet screen information. Upon detection the trigger operation for the first bullet screen information, the terminal displays a bullet screen information input interface, and sends second bullet screen information when a control for sending bullet screen information is triggered. The second bullet screen information includes the question identifier of the first bullet screen information, and the question identifier is used for enabling the server to establish a question-answer association between the first bullet screen information and the second bullet screen information according to the question identifier. For example, content of the second bullet screen information 2104 sent by the terminal is that “Sikong was an official position in charge of buildings before Han Dynasty and responsible for supervising residential space, but later became a high position without much power,” which is input and confirmed to send by the user A.

In the application example, the server receives the second bullet screen information sent by the terminal of the user A, and establishes a question-answer association between the second bullet screen information and the first bullet screen information according to the question identifier included in the second bullet screen information. For example, the server may determine the second bullet screen information as answer bullet screen information corresponding to the first bullet screen information.

In the application example, the server may send related data of the determined question bullet screen information and the answer bullet screen information corresponding to the question bullet screen information to a discussion page, so that the related data of the question bullet screen information and the answer bullet screen information is displayed in the discussion page. For example, as shown in FIG. 21a, the server sends the related data of the question bullet screen information and the answer bullet screen information corresponding to the question bullet screen information to the discussion page, and the related data of the question bullet screen information and the answer bullet screen information is displayed in the discussion page, for use in user communication.

For example, the title of the discussion page may be the question bullet screen information (for example, why is he called Sikong). The main body of the discussion page may be the question bullet screen information and a playing time point of the multimedia resource corresponding to the question bullet screen information. An initiation account of the discussion page may be an account sending the question bullet screen information. An initiation time of the discussion page may be time when the question bullet screen information is sent. The discussion page may include multiple replies, and reply content is answer bullet screen information. A replying account may be an account sending the answer bullet screen information. A reply time maybe time when the answer bullet screen information is sent. For example, as shown in FIG. 21b, content (second bullet screen information) replied by the user A is displayed in the discussion page.

In the application example, as shown in FIG. 21a, a portal 2106 may be displayed in the discussion page. By clicking the portal, the user may be redirected to the playing interface of the drama series, to play the drama series at the playing time point (for example, 00:37:59 of the fourth episode) corresponding to the question bullet screen information.

In the application example, the server may acquire second reply information (for example, content replied by the user C in the discussion page) for the question bullet screen information from the discussion page, and send the second reply information to the terminal playing the multimedia resource, so that the terminal displays the second reply information in a display mode corresponding to bullet screen information.

According to the embodiments of this disclosure, it is determined whether first bullet screen information includes a question identifier when the first bullet screen information is received during playing of a multimedia resource, the first bullet screen information is determined as question bullet screen information when the first bullet screen information includes a question identifier, and the first bullet screen information is displayed in a display mode corresponding to the question bullet screen information, thereby enriching display modes of bullet screen information and improving the effectiveness of interaction via the bullet screen information.

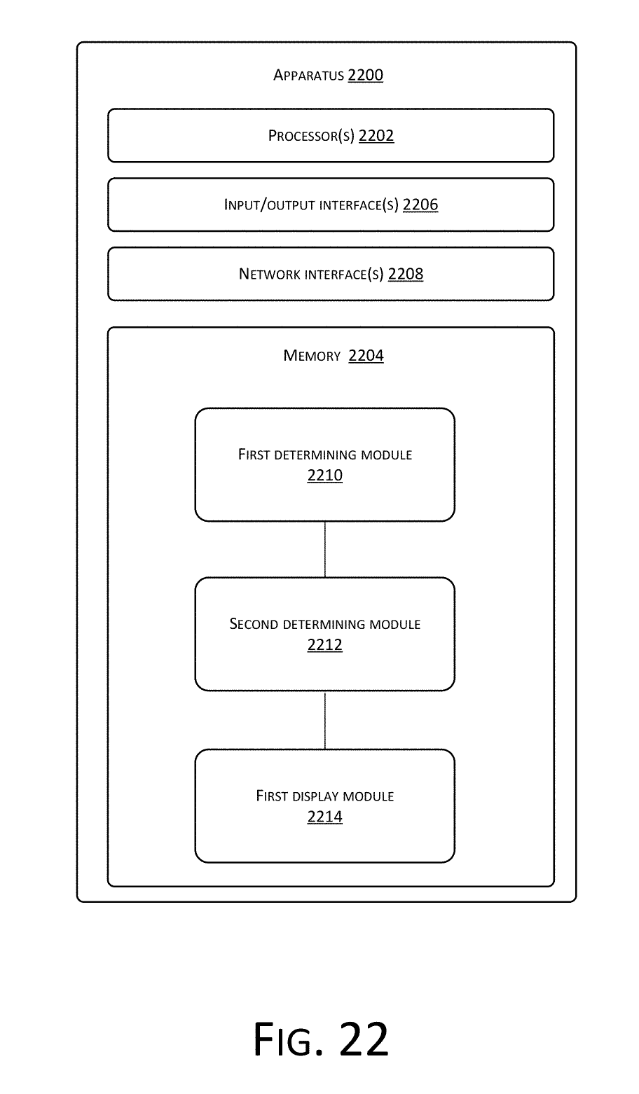

FIG. 22 is a block diagram of a bullet screen display apparatus according to an example diagram. As shown in FIG. 22, an apparatus 2200 is applied in a terminal. The apparatus 2200 includes one or more processor(s) 2202 or data processing unit(s) and memory 2204. The apparatus 2200 may further include one or more input/output interface(s) 2206 and one or more network interface(s) 2208. The memory 2204 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 2204 may store therein a plurality of modules or units including:

a first determining module 2210 configured to determine whether first bullet screen information includes a question identifier when the first bullet screen information is received during playing of a multimedia resource;

a second determining module 2212 configured to determine the first bullet screen information as question bullet screen information when the first bullet screen information includes a question identifier; and

a first display module 2214 configured to display the first bullet screen information on a playing interface of the multimedia resource in a display mode corresponding to the question bullet screen information.

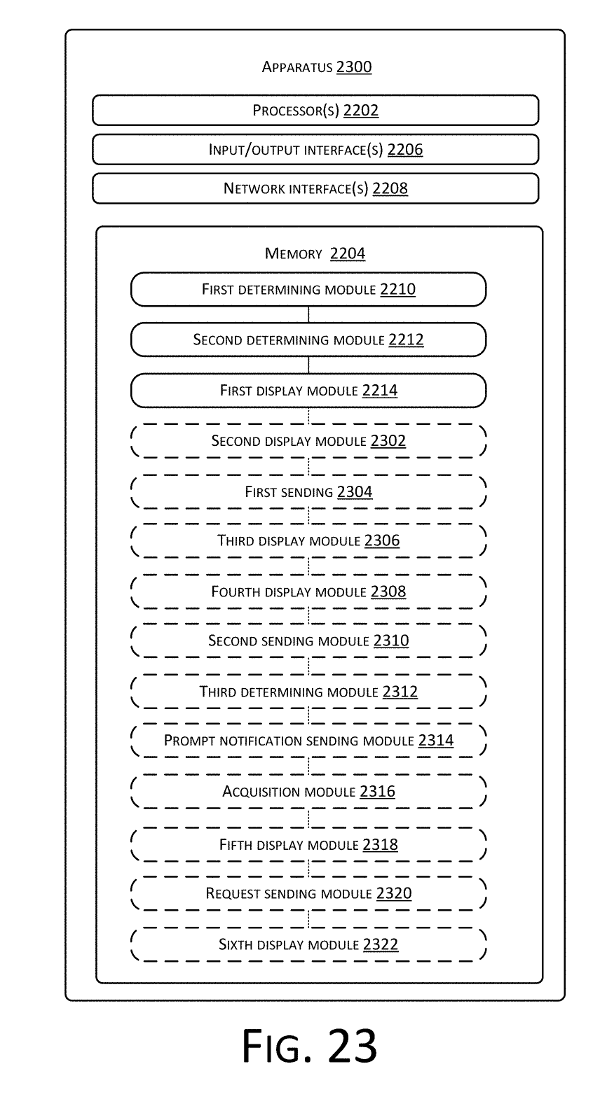

FIG. 23 is a block diagram of a bullet screen display apparatus according to an example diagram. As shown in FIG. 23, in an example implementation, based on the apparatus 2200, an apparatus 2300 includes one or more processor(s) 2202 or data processing unit(s) and memory 2204. The apparatus 2300 may further include one or more input/output interface(s) 2206 and one or more network interface(s) 2208. The memory 2204 is an example of computer readable medium or media.

The memory 2204 may further store therein a plurality of modules or units including:

a second display module 2302 configured to display a bullet screen information input interface upon detection of a trigger operation for the first bullet screen information; and

a first sending module 2304 configured to send second bullet screen information when a control for sending bullet screen information is triggered, wherein the second bullet screen information includes the question identifier of the first bullet screen information, and the question identifier is used for enabling a server to establish a question-answer association between the first bullet screen information and the second bullet screen information according to the question identifier.

As shown in FIG. 23, in another example implementation, the apparatus 2300 may further include the following modules or units stored on the memory 2204:

a third display module 2306 configured to display a bullet screen information input interface when a control for editing bullet screen information is triggered;

a fourth display module 2308 configured to display question tag information in an information input area of the bullet screen information input interface when a question control in the bullet screen information input interface is triggered, wherein the question tag information is used for indicating that the type of third bullet screen information to be input is candidate question bullet screen information; and

a second sending module 2310 configured to send the third bullet screen information when a control for sending bullet screen information is triggered, wherein the third bullet screen information includes a candidate question identifier, so that a server determines the type of the third bullet screen information according to the candidate question identifier.

As shown in FIG. 23, in another example implementation, the apparatus 2300 may further include the following modules or units stored on the memory 2204:

a third determining module 2312 configured to determine whether fourth bullet screen information includes an answer identifier when the fourth bullet screen information is received; and

a prompt notification sending module 2314 configured to send a prompt notification on the playing interface of the multimedia resource when the fourth bullet screen information includes an answer identifier indicating that the fourth bullet screen information is recommended answer bullet screen information for the third bullet screen information.

As shown in FIG. 23, in another example implementation, the apparatus 2300 may further include the following modules or units stored on the memory 2204:

an acquisition module 2316 configured to acquire fifth bullet screen information to be displayed when the multimedia resource is played to a target time point, wherein the fifth bullet screen information is question bullet screen information related to the multimedia resource at the target time point; and

a fifth display module 2318 configured to display the fifth bullet screen information in a display mode corresponding to the fifth bullet screen information.

As shown in FIG. 23, in another example implementation, the apparatus 2300 may further include the following modules or units stored on the memory 2204:

a request sending module 2320 configured to send a reply displaying request for the fifth bullet screen information to a server upon detection of a trigger operation for the fifth bullet screen information; and

a sixth display module 2322 configured to display first reply information in a target display area in the playing interface of the multimedia resource when the first reply information for the fifth bullet screen information in a discussion page returned by the server is received.

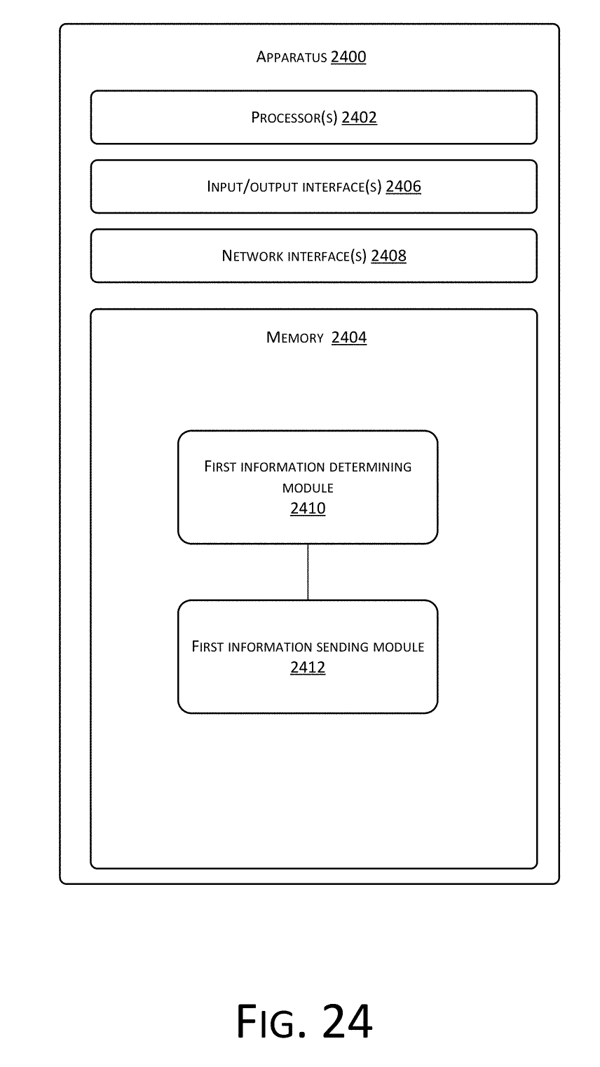

FIG. 24 is a block diagram of a bullet screen display apparatus according to an example diagram. As shown in FIG. 24, an apparatus 2400 is applied in a server and includes one or more processor(s) 2402 or data processing unit(s) and memory 2404. The apparatus 2400 may further include one or more input/output interface(s) 2406 and one or more network interface(s) 2408. The memory 2404 is an example of computer readable medium or media.

The memory 2404 may further store therein a plurality of modules or units including:

a first information determining module 2410 configured to determine question bullet screen information in multiple pieces of bullet screen information for a multimedia resource, wherein the question bullet screen information includes a question identifier; and

a first information sending module 2412 configured to send the question bullet screen information to a terminal playing the multimedia resource, so that the terminal displays the question bullet screen information in a display mode corresponding to the question bullet screen information.

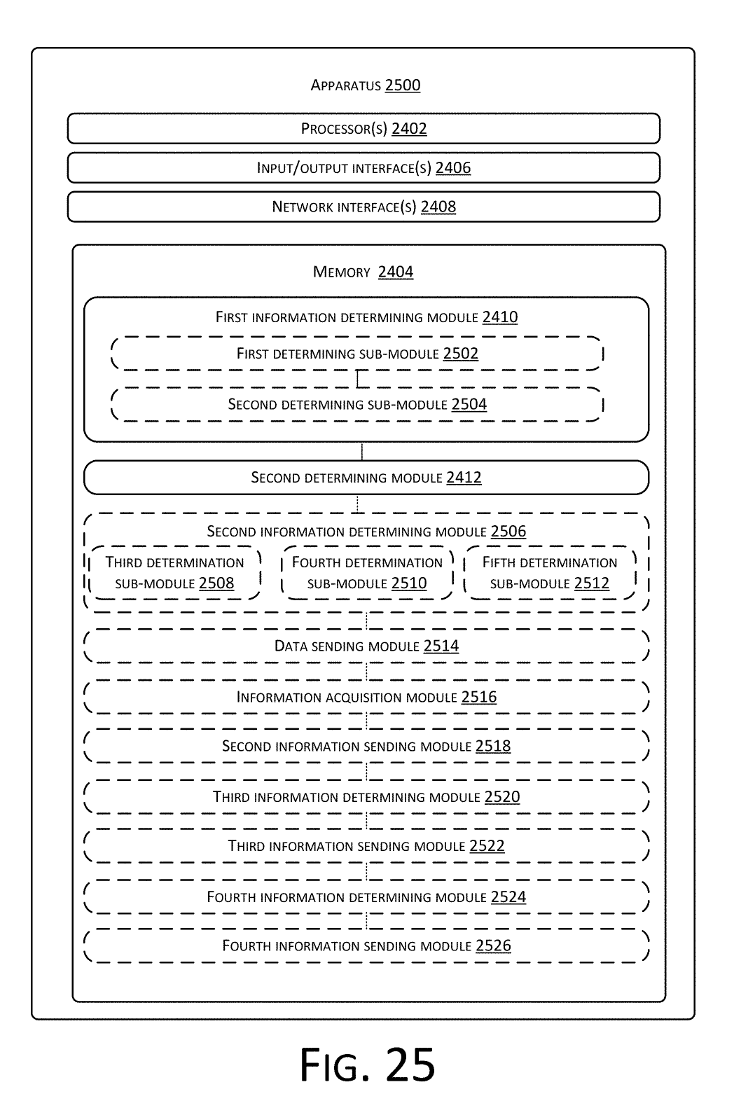

FIG. 25 is a block diagram of a bullet screen display apparatus according to an example diagram. As shown in FIG. 25, in an example implementation, in an apparatus 2500, the first information determining module 2410 includes:

a first determining sub-module 2502 configured to determine multiple pieces of candidate question bullet screen information for the multimedia resource; and

a second determining sub-module 2504 configured to determine the question bullet screen information from the multiple pieces of candidate question bullet screen information.

As shown in FIG. 25, in an example implementation, the first determining sub-module 2502 is configured to:

determine bullet screen information including a question keyword as the candidate question bullet screen information.

As shown in FIG. 25, in an example implementation, the apparatus 2500 further includes the following modules or units stored on the memory 2404:

a second information determining module 2506 configured to determine answer bullet screen information corresponding to the question bullet screen information, wherein the answer bullet screen information includes an answer identifier used for indicating that the answer bullet screen information is answer bullet screen information corresponding to the question bullet screen information.

As shown in FIG. 25, in an example implementation, the second information determining module 2506 includes at least one of the following sub-modules:

a third determining sub-module 2508 configured to determine target bullet screen information matching the question keyword as candidate answer bullet screen information, and determine the answer bullet screen information from the candidate answer bullet screen information, wherein the target bullet screen information is bullet screen information that is received by the server in a target time interval after the question bullet screen information is displayed;

a fourth determining sub-module 2510 configured to receive second bullet screen information sent by the terminal, and determine the second bullet screen information as the answer bullet screen information, wherein the second bullet screen information includes the question identifier of the question bullet screen information; and

a fifth determining sub-module 2512 configured to acquire shared information associated with the question bullet screen information from a sharing platform, and determine the answer bullet screen information according to the shared information.

As shown in FIG. 25, in another example implementation, the apparatus 2500 may further include the following modules or units stored on the memory 2404:

a data sending module 2514 configured to send related data of the question bullet screen information and the answer bullet screen information to a discussion page, so that the related data of the question bullet screen information and the answer bullet screen information is displayed on the discussion page.

As shown in FIG. 25, in another example implementation, the apparatus 2500 may further include the following modules or units stored on the memory 2404:

an information acquisition module 2516 configured to acquire second reply information for the question bullet screen information in the discussion page; and

a second information sending module 2518 configured to send the second reply information to the terminal playing the multimedia resource, so that the terminal displays the second reply information in a display mode corresponding to bullet screen information.

As shown in FIG. 25, in another example implementation, the apparatus 2500 may further include the following modules or units stored on the memory 2404:

a third information determining module 2520 configured to determine a target time point of the multimedia resource and fifth bullet screen information corresponding to the target time point; and

a third information sending module 2522 configured to send the fifth bullet screen information when an acquisition request of the terminal for the fifth bullet screen information is received, so that the terminal displays the fifth bullet screen information in a display mode corresponding to the fifth bullet screen information.

As shown in FIG. 25, in another example implementation, the apparatus 2500 may further include the following modules or units stored on the memory 2404:

a fourth information determining module 2524 configured to determine first reply information for the fifth bullet screen information in a discussion page when a reply displaying request sent by the terminal for the fifth bullet screen information is received; and

a fourth information sending module 2526 configured to send the first reply information to the terminal, so that the terminal displays the first reply information in a target display area in a playing interface of the multimedia resource.

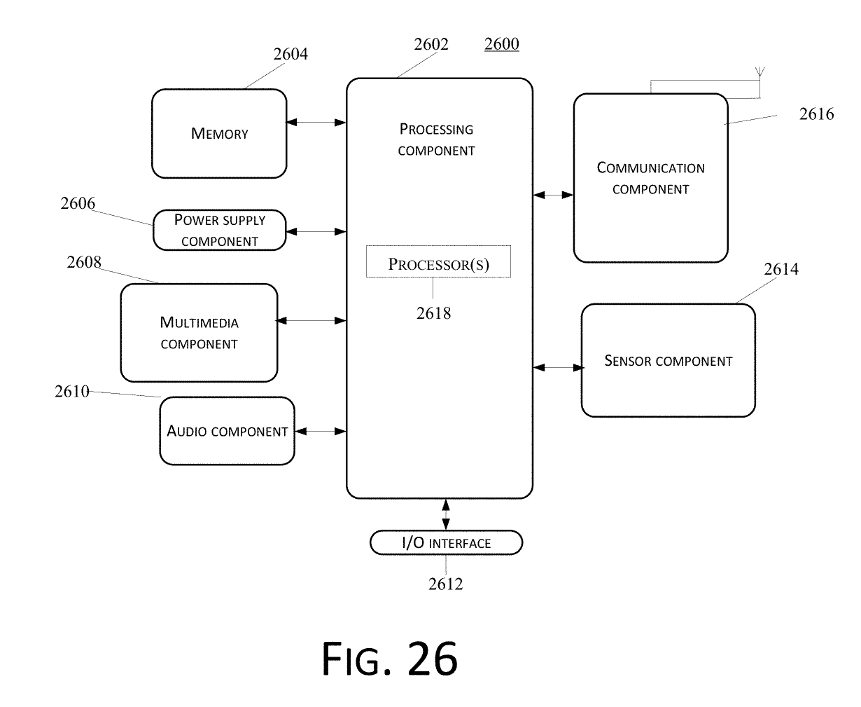

FIG. 26 is a block diagram of a bullet screen display apparatus according to an example diagram. For example, the apparatus 2600 may be a mobile phone, a computer, a digital broadcasting terminal, a message transceiver, a game console, a tablet device, medical equipment, fitness equipment, a personal digital assistant, or the like.

Referring to FIG. 26, the apparatus 2600 may include one or more of the following components: a processing component 2602, a memory 2604, a power supply component 2606, a multimedia component 2608, an audio component 2610, an input/output (I/O) interface 2612, a sensor component 2614, and a communication component 2616.

The processing component 2602 generally controls overall operations of the apparatus 2600, for example, operations related to display, phone calls, data communication, camera operations, and recording operations. The processing component 2602 may include one or more processors 2618 for executing instructions to complete all or some of the steps of the foregoing methods. In addition, the processing component 2602 may include one or more modules to facilitate interaction between the processing component 2602 and other components. For example, the processing component 2602 may include a multimedia module to facilitate interaction between the multimedia component 2608 and the processing component 2602.

The memory 2604 is configured to store various types of data to support operations on the apparatus 2600. Examples of the data include instructions of any application program or method for operating on the apparatus 2600, contact data, address book data, messages, pictures, videos, and the like. The memory 2604 may be implemented by any type of volatile or non-volatile storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disc.

The power supply component 2606 supplies power for various components of the apparatus 2600. The power supply component 2606 may include a power management system, one or more power supplies, and other components related to generation, management, and power distribution of the apparatus 2600.

The multimedia component 2608 includes a screen that provides an output interface between the apparatus 2600 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor not only may sense the boundary of a touch or slide action, but also may detect duration and pressure related to the touch or slide action. In some embodiments, the multimedia component 808 includes a front camera and/or a rear camera. When the apparatus 2600 is in an operating mode, for example, in a shooting mode or a video mode, the front camera and/or rear camera may receive external multimedia data. Each front camera and rear camera may be a fixed optical lens system or have focusing and optical zooming capabilities.

The audio component 2610 is configured to output and/or input audio signals. For example, the audio component 2610 includes a microphone (MIC). When the apparatus 2600 is in an operating mode, for example, in a call mode, a recording mode or a speech recognition mode, the microphone is configured to receive external audio signals. The received audio signals may be further stored in the memory 2604 or sent via the communication component 2616. In some embodiments, the audio component 2610 further includes a loudspeaker configured to output audio signals.

The I/O interface 2612 provides an interface between the processing component 2602 and a peripheral interface module. The peripheral interface module may be a keyboard, a click wheel, buttons, or the like. The buttons may include, but are not limited to, a homepage button, a volume button, a start button, and a locking button.

The sensor component 2614 includes one or more sensors configured to provide state estimation for the apparatus 2600 in various aspects. For example, the sensor component 2614 may detect an ON/OFF state of the apparatus 2600, relative positioning of components (for example, the component is a display or keypad of the apparatus 2600). The sensor component 2614 may further detect changes in the position of the apparatus 2600 or a component of the apparatus 2600, presence or absence of touch between a user and the apparatus 2600, the orientation or acceleration/deceleration of the apparatus 2600, and temperature changes of the apparatus 2600. The sensor component 2614 may include a proximity detector configured to detect the presence of objects nearby without any physical touch. The sensor component 2614 may further include an optical sensor, such as a CMOS or a CCD image sensor, for use in an imaging application. In some embodiments, the sensor component 2614 may further include an acceleration sensor, a gyroscope sensor, a magnetic sensor, a pressure sensor, or a temperature sensor.

The communication component 2616 is configured to facilitate wired or wireless communication between the apparatus 2600 and other devices. The apparatus 2600 may access a wireless network based on a communication standard, such as WiFi, 2G, 3G, or a combination thereof. In an example embodiment, the communication component 2616 receives a broadcast signal or broadcast-related information from an external broadcast management system through a broadcast channel. In an example embodiment, the communication component 2616 further includes a near field communication (NFC) module to facilitate short-range communication. For example, the NFC module may be implemented based on a radio frequency identification (RFID) technology, an Infrared Data Association (IrDA) technology, an ultra-wideband (UWB) technology, a Bluetooth (BT) technology and other technologies.

In an example embodiment, the apparatus 2600 may be implemented by one or more application-specific integrated circuits (ASICs), a digital signal processor (DSP), a digital signal processing device (DSPD), a programmable logic device (PLD), a field programmable gate array (FPGA), a controller, a micro controller, a microprocessor or other electronic elements, for performing the foregoing method.

In an example embodiment, a non-volatile computer-readable storage medium is further provided, for example, the memory 804 including computer program instructions. The computer program instructions may be executed by the processor 820 of the apparatus 800 to complete the foregoing method.

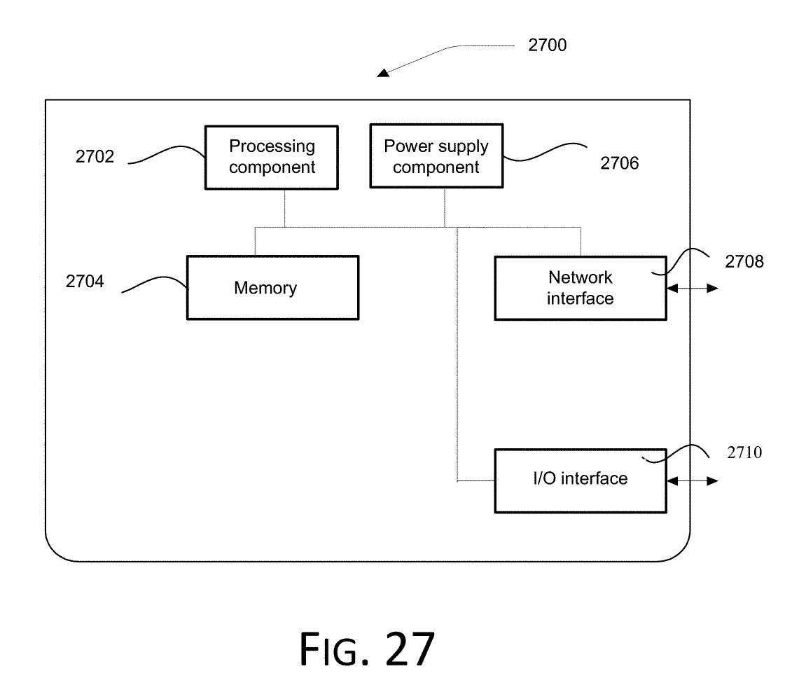

FIG. 27 is a block diagram of a bullet screen display apparatus according to an example embodiment. For example, the apparatus 2700 may be provided as a server. Referring to FIG. 27, the apparatus 2700 includes a processing component 2702, and further includes one or more processors, and a memory resource represented by a memory 2704, which is configured to store instructions executable by the processing component 2702, such as an application program. The application program stored in the memory 2704 may include one or more modules each corresponding to a group of instructions. In addition, the processing component 2702 is configured to execute the instructions to perform the foregoing method.

The apparatus 2700 further includes a power supply component 2706 configured to manage the power supply of the apparatus 2700, a wired or wireless network interface 2708 configured to connect the apparatus 2700 to a network, and an input/output (I/O) interface 2710. The apparatus 1900 may operate based on an operating system stored in the memory 2704, for example, Windows Server™, Mac OS X™, Unix™, Linux™, FreeBSD™ or the like.

In an example embodiment, a non-volatile computer-readable storage medium is further provided, for example, a memory 2704 including computer program instructions. The computer program instructions may be executed by the processing component 2702 of the apparatus 2700 to complete the foregoing method.

This disclosure may be a system, a method, and/or a computer program product. The computer program product may include a computer-readable storage medium which carries computer-readable program instructions for enabling a processor to implement various aspects of this disclosure.

The computer-readable storage medium may be a physical device capable of maintaining and storing instructions that are used by instruction execution devices. For example, the computer-readable storage medium may be, but is not limited to, an electric storage device, a magnetic storage device, an optical storage device, an electromagnetic storage device, a semiconductor storage device, or any proper combination of the above. A more specific example (not an exhaustive list) of the computer-readable storage medium includes: a portable computer disk, a hard drive, a random access memory (RAM), a read-only memory (ROM), an erasable programmable read-only memory (EPROM or flash drive), a static random access memory (SRAM), a compact disk read-only memory (CD-ROM), a digital versatile disc (DVD), a memory stick, a floppy disk, a mechanical encoding device, a punch card or a bump structure inside a groove that, for example, stores instructions thereon, and any proper combination of the above. The computer-readable storage medium used here cannot be construed to be transient signals themselves, such as radio waves or other freely propagated electromagnetic waves, electromagnetic waves propagated through a waveguide or other transmission media (e.g. an optical pulse passing through a fiber optic cable), or electric signals transmitted through an electric wire.

The computer-readable program instructions described here may be downloaded from a computer-readable storage medium to each computing/processing device, or downloaded to an external computer or an external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter or network port in each computing/processing device receives computer-readable program instructions from the network, and forwards the computer-readable program instructions for storage in a computer-readable storage medium in each computing/processing device.

The computer program instructions for executing operations of this disclosure may be assembly language instructions, instruction set architecture (ISA) instructions, machine instructions, machine-related instructions, microcode, firmware instructions, status setting data, or source codes or target codes compiled in any combination of one or more programming languages. The programming languages include object oriented programming languages, such as Smalltalk, C++, etc., and conventional procedural programming languages, such as C language or similar programming languages. The computer-readable program instructions may be executed fully on a user computer, executed partially on a user computer, executed as an independent software package, executed partially on a user computer and partially on a remote computer, or executed fully on a remote computer or a server. In a circumstance in which a remote computer is involved, the remote computer may be connected to a user computer via any type of network, including a local area network (LAN) or a wide area network (WAN), or the remote computer may be connected to an external computer (e.g. by using an Internet service provider to connect via the Internet). In some embodiments, an electronic circuit, such as a programmable logic circuit, a field programmable gate array (FPGA), or a programmable logic array (PLA), is customized by using status information of computer-readable program instructions. The electronic circuit may execute the computer-readable program instructions to implement various aspects of this disclosure.

Various aspects of this disclosure are described with reference to flowcharts and/or block diagrams of the method, apparatus (system) and computer program product according to the embodiments of this disclosure. It should be understood that each block in the flowcharts and/or block diagrams and combinations of the blocks in the flowcharts and/or block diagrams may be implemented by computer-readable program instructions.

These computer-readable program instructions may be provided to a processor of a general-purpose computer, a dedicated-purpose computer, or other programmable data processing apparatuses to produce a machine, such that these instructions, when executed by the processor of a computer or other programmable data processing apparatuses, produce a device to implement functions/actions prescribed in one or more blocks in the flowcharts and/or block diagrams. Alternatively, these computer-readable program instructions may also be stored in a computer-readable storage medium. These instructions instruct a computer, a programmable data processing apparatus, and/or other devices to work in a particular manner, such that the computer-readable storage medium storing the instructions includes a manufactured article that includes instructions for implementing various aspects of functions/actions prescribed in one or more blocks in the flowcharts and/or block diagrams.

These computer-readable program instructions may also be loaded to a computer, other programmable data processing apparatuses, or other devices, such that a series of operational steps are performed on the computer, other programmable data processing apparatuses, or other devices, thereby generating a process of computer implementation, so that the instructions executed on the computer, other programmable data processing apparatuses, or other devices implement functions/actions prescribed in one or more blocks in the flowcharts and/or block diagrams.

The flowcharts and block diagrams in the accompanying drawings display system architectures, functions and operations that may be implemented by the systems, methods and computer program products according to a plurality of embodiments of this disclosure. In this regard, each block in the flowcharts or block diagrams may represent a part of a module, a program segment or an instruction, and the part of the module, program segment or instruction includes one or more executable instructions for implementing prescribed logic functions. In some alternative implementations, functions marked in the blocks may also take place in an order different from the one marked in the accompanying drawings. For example, two consecutive blocks may actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated and hardware-based system for executing prescribed functions or actions, or may be implemented by a combination of dedicated hardware and computer instructions.

The embodiments of this disclosure are described above, and the description above is illustrative, rather than exhaustive. Moreover, the description above is not limited to the disclosed embodiments. Without departing from the scope and spirit of the described embodiments, many modification and variations are obvious to those skilled in the art. The terms used here are selected with an intention to explain, in the best way, the principles and actual applications of the embodiments or improvements to the technologies on the market, or to enable those of ordinary skill in the art to understand the embodiments disclosed here.

The present disclosure may further be understood with clauses as follows.

Clause 1. A bullet screen display method applied in a terminal, comprising:

determining whether first bullet screen information comprises a question identifier when the first bullet screen information is received during playing of a multimedia resource;

determining the first bullet screen information as question bullet screen information when the first bullet screen information comprises a question identifier; and

displaying the first bullet screen information on a playing interface of the multimedia resource in a display mode corresponding to the question bullet screen information.

Clause 2. The method of clause 1, further comprising:

displaying a bullet screen information input interface upon detection of a trigger operation for the first bullet screen information; and

sending second bullet screen information when a control for sending bullet screen information is triggered, wherein the second bullet screen information comprises the question identifier of the first bullet screen information, and the question identifier is used for enabling a server to establish a question-answer association between the first bullet screen information and the second bullet screen information according to the question identifier.

Clause 3. The method of clause 1, further comprising:

displaying a bullet screen information input interface when a control for editing bullet screen information is triggered;

displaying question tag information in an information input area of the bullet screen information input interface when a question control in the bullet screen information input interface is triggered, wherein the question tag information is used for indicating that the type of third bullet screen information to be input is candidate question bullet screen information; and

sending the third bullet screen information when a control for sending bullet screen information is triggered, wherein the third bullet screen information comprises a candidate question identifier, so that a server determines the type of the third bullet screen information according to the candidate question identifier.

Clause 4. The method of clause 3, further comprising:

determining whether fourth bullet screen information comprises an answer identifier when the fourth bullet screen information is received; and

sending a prompt notification on the playing interface of the multimedia resource when the fourth bullet screen information comprises an answer identifier indicating that the fourth bullet screen information is recommended answer bullet screen information for the third bullet screen information.

Clause 5. The method of clause 1, further comprising:

acquiring fifth bullet screen information to be displayed when the multimedia resource is played to a target time point, wherein the fifth bullet screen information is question bullet screen information related to the multimedia resource at the target time point; and

displaying the fifth bullet screen information in a display mode corresponding to the fifth bullet screen information.

Clause 6. The method of clause 5, further comprising:

sending a reply displaying request for the fifth bullet screen information to a server upon detection of a trigger operation for the fifth bullet screen information; and

displaying first reply information in a target display area in the playing interface of the multimedia resource when the first reply information for the fifth bullet screen information in a discussion page returned by the server is received.

Clause 7. A bullet screen display method applied in a server, comprising:

determining question bullet screen information in multiple pieces of bullet screen information for a multimedia resource, wherein the question bullet screen information comprises a question identifier; and

sending the question bullet screen information to a terminal playing the multimedia resource, so that the terminal displays the question bullet screen information in a display mode corresponding to the question bullet screen information.

Clause 8. The method of clause 7, wherein the step of determining question bullet screen information in multiple pieces of bullet screen information for a multimedia resource comprises:

determining multiple pieces of candidate question bullet screen information for the multimedia resource; and

determining the question bullet screen information from the multiple pieces of candidate question bullet screen information.

Clause 9. The method of clause 8, wherein the step of determining multiple pieces of candidate question bullet screen information for the multimedia resource comprises:

determining bullet screen information comprising a question keyword as the candidate question bullet screen information.

Clause 10. The method of clause 7, further comprising:

determining answer bullet screen information corresponding to the question bullet screen information, wherein the answer bullet screen information comprises an answer identifier used for indicating that the answer bullet screen information is answer bullet screen information corresponding to the question bullet screen information.

Clause 11. The method of clause 10, wherein the step of determining answer bullet screen information corresponding to the question bullet screen information comprises at least one of the following manners:

determining target bullet screen information matching the question keyword as candidate answer bullet screen information, and determining the answer bullet screen information from the candidate answer bullet screen information, wherein the target bullet screen information is bullet screen information that is received by the server in a target time interval after the question bullet screen information is displayed;

receiving second bullet screen information sent by the terminal, and determining the second bullet screen information as the answer bullet screen information, wherein the second bullet screen information comprises the question identifier of the question bullet screen information; and

acquiring shared information associated with the question bullet screen information from a sharing platform, and determining the answer bullet screen information according to the shared information.

Clause 12. The method of clause 10, further comprising:

sending related data of the question bullet screen information and the answer bullet screen information to a discussion page, so that the related data of the question bullet screen information and the answer bullet screen information is displayed on the discussion page.

Clause 13. The method of clause 12, further comprising:

acquiring second reply information for the question bullet screen information in the discussion page; and

sending the second reply information to the terminal playing the multimedia resource, so that the terminal displays the second reply information in a display mode corresponding to bullet screen information.

Clause 14. The method of clause 7, further comprising:

determining a target time point of the multimedia resource and fifth bullet screen information corresponding to the target time point; and

sending the fifth bullet screen information when an acquisition request of the terminal for the fifth bullet screen information is received, so that the terminal displays the fifth bullet screen information in a display mode corresponding to the fifth bullet screen information.

Clause 15. The method of clause 14, further comprising:

determining first reply information for the fifth bullet screen information in a discussion page when a reply displaying request sent by the terminal for the fifth bullet screen information is received; and

sending the first reply information to the terminal, so that the terminal displays the first reply information in a target display area in a playing interface of the multimedia resource.

Clause 16. A bullet screen display apparatus applied in a terminal, comprising:

a first determining module configured to determine whether first bullet screen information comprises a question identifier when the first bullet screen information is received during playing of a multimedia resource;

a second determining module configured to determine the first bullet screen information as question bullet screen information when the first bullet screen information comprises a question identifier; and

a first display module configured to display the first bullet screen information on a playing interface of the multimedia resource in a display mode corresponding to the question bullet screen information.

Clause 17. The apparatus of clause 16, further comprising:

a second display module configured to display a bullet screen information input interface upon detection of a trigger operation for the first bullet screen information; and

a first sending module configured to send second bullet screen information when a control for sending bullet screen information is triggered, wherein the second bullet screen information comprises the question identifier of the first bullet screen information, and the question identifier is used for enabling a server to establish a question-answer association between the first bullet screen information and the second bullet screen information according to the question identifier.

Clause 18. The apparatus of clause 16, further comprising:

a third display module configured to display a bullet screen information input interface when a control for editing bullet screen information is triggered;

a fourth display module configured to display question tag information in an information input area of the bullet screen information input interface when a question control in the bullet screen information input interface is triggered, wherein the question tag information is used for indicating that the type of third bullet screen information to be input is candidate question bullet screen information; and

a second sending module configured to send the third bullet screen information when a control for sending bullet screen information is triggered, wherein the third bullet screen information comprises a candidate question identifier, so that a server determines the type of the third bullet screen information according to the candidate question identifier.

Clause 19. The apparatus of clause 18, further comprising:

a third determining module configured to determine whether fourth bullet screen information comprises an answer identifier when the fourth bullet screen information is received; and

a prompt notification sending module configured to send a prompt notification on the playing interface of the multimedia resource when the fourth bullet screen information comprises an answer identifier indicating that the fourth bullet screen information is recommended answer bullet screen information for the third bullet screen information.

Clause 20. The apparatus of clause 16, further comprising:

an acquisition module configured to acquire fifth bullet screen information to be displayed when the multimedia resource is played to a target time point, wherein the fifth bullet screen information is question bullet screen information related to the multimedia resource at the target time point; and

a fifth display module configured to display the fifth bullet screen information in a display mode corresponding to the fifth bullet screen information.

Clause 21. The apparatus of clause 20, further comprising:

a request sending module configured to send a reply displaying request for the fifth bullet screen information to a server upon detection of a trigger operation for the fifth bullet screen information; and

a sixth display module configured to display first reply information in a target display area in the playing interface of the multimedia resource when the first reply information for the fifth bullet screen information in a discussion page returned by the server is received.

Clause 22. A bullet screen display apparatus applied in a server, comprising:

a first information determining module configured to determine question bullet screen information in multiple pieces of bullet screen information for a multimedia resource, wherein the question bullet screen information comprises a question identifier; and

a first information sending module configured to send the question bullet screen information to a terminal playing the multimedia resource, so that the terminal displays the question bullet screen information in a display mode corresponding to the question bullet screen information.

Clause 23. The apparatus of clause 22, wherein the first information determining module comprises:

a first determining sub-module configured to determine multiple pieces of candidate question bullet screen information for the multimedia resource; and

a second determining sub-module configured to determine the question bullet screen information from the multiple pieces of candidate question bullet screen information.

Clause 24. The apparatus of clause 23, wherein the first determining sub-module is configured to:

determine bullet screen information comprising a question keyword as the candidate question bullet screen information.

Clause 25. The apparatus of clause 22, further comprising:

a second information determining module configured to determine answer bullet screen information corresponding to the question bullet screen information, wherein the answer bullet screen information comprises an answer identifier used for indicating that the answer bullet screen information is answer bullet screen information corresponding to the question bullet screen information.

Clause 26. The apparatus of clause 25, wherein the second information determining module comprises at least one of the following sub-modules:

a third determining sub-module configured to determine target bullet screen information matching the question keyword as candidate answer bullet screen information, and determine the answer bullet screen information from the candidate answer bullet screen information, wherein the target bullet screen information is bullet screen information that is received by the server in a target time interval after the question bullet screen information is displayed;

a fourth determining sub-module configured to receive second bullet screen information sent by the terminal, and determine the second bullet screen information as the answer bullet screen information, wherein the second bullet screen information comprises the question identifier of the question bullet screen information; and

a fifth determining sub-module configured to acquire shared information associated with the question bullet screen information from a sharing platform, and determine the answer bullet screen information according to the shared information.

Clause 27. The apparatus of clause 25, further comprising:

a data sending module configured to send related data of the question bullet screen information and the answer bullet screen information to a discussion page, so that the related data of the question bullet screen information and the answer bullet screen information is displayed on the discussion page.

Clause 28. The apparatus of clause 27, further comprising:

an information acquisition module configured to acquire second reply information for the question bullet screen information in the discussion page; and

a second information sending module configured to send the second reply information to the terminal playing the multimedia resource, so that the terminal displays the second reply information in a display mode corresponding to bullet screen information.

Clause 29. The apparatus of clause 22, further comprising:

a third information determining module configured to determine a target time point of the multimedia resource and fifth bullet screen information corresponding to the target time point; and

a third information sending module configured to send the fifth bullet screen information when an acquisition request of the terminal for the fifth bullet screen information is received, so that the terminal displays the fifth bullet screen information in a display mode corresponding to the fifth bullet screen information.

Clause 30. The apparatus of clause 29, further comprising:

a fourth information determining module configured to determine first reply information for the fifth bullet screen information in a discussion page when a reply displaying request sent by the terminal for the fifth bullet screen information is received; and

a fourth information sending module configured to send the first reply information to the terminal, so that the terminal displays the first reply information in a target display area in a playing interface of the multimedia resource.

Clause 31. A bullet screen display apparatus, comprising:

a first processor; and

a first memory configured to store instructions executable by the first processor,

wherein the first processor is configured to perform the method of any of clauses 1 to 6.

Clause 32. A non-volatile computer-readable storage medium, having computer program instructions stored thereon, wherein the method of any of clauses 1 to 6 is implemented when the computer program instructions are executed by a first processor.

Clause 33. A bullet screen display apparatus, comprising:

a second processor; and

a second memory configured to store instructions executable by the second processor,

wherein the second processor is configured to perform the method of any of clauses 7 to 15.

Clause 34. A computer-readable storage medium, having computer program instructions stored thereon, wherein the method of any of clauses 7 to 15 is implemented when the computer program instructions are executed by a second processor.

What is claimed is:

1. A method comprising:
determining that first bullet screen information is received during playing of a multimedia resource;
determining that the first bullet screen information comprises a question identifier;
determining the first bullet screen information as question bullet screen information; and
displaying the first bullet screen information on a playing interface of the multimedia resource in a display mode corresponding to the question bullet screen information.

2. The method of claim 1, further comprising:
displaying a bullet screen information input interface upon detection of a trigger operation for the first bullet screen information; and
sending second bullet screen information when a control for sending bullet screen information is triggered, wherein the second bullet screen information comprises the question identifier of the first bullet screen information, and the question identifier is used for enabling a server to establish a question-answer association between the first bullet screen information and the second bullet screen information according to the question identifier.

3. The method of claim 2, wherein the second bullet screen information is bullet screen information replied by a user when the first bullet screen information is presented at a display.

4. The method of claim 1, further comprising:
displaying a bullet screen information input interface when a control for editing bullet screen information is triggered;
displaying question tag information in an information input area of the bullet screen information input interface when a question control in the bullet screen information input interface is triggered, wherein the question tag information indicates that a type of third bullet screen information to be input is candidate question bullet screen information; and
sending the third bullet screen information when a control for sending bullet screen information is triggered, wherein the third bullet screen information comprises a candidate question identifier, so that a server determines the type of the third bullet screen information according to the candidate question identifier.

5. The method of claim 4, wherein the third bullet screen information is a question bullet screen sent by a user.

6. The method of claim 4, further comprising:
determining that fourth bullet screen information comprises an answer identifier when the fourth bullet screen information is received, the answer identifier indicating that the fourth bullet screen information is recommended answer bullet screen information for the third bullet screen information; and
sending a prompt notification on the playing interface of the multimedia resource.

7. The method of claim 6, wherein the fourth bullet screen information is determined by a server as the recommended answer bullet screen information for the third bullet screen information.

8. The method of claim 1, further comprising:
acquiring fifth bullet screen information to be displayed when the multimedia resource is played to a target time point, wherein the fifth bullet screen information is question bullet screen information related to the multimedia resource at the target time point; and
displaying the fifth bullet screen information in a display mode corresponding to the fifth bullet screen information.

9. The method of claim 8, further comprising:
sending a reply displaying request for the fifth bullet screen information to a server upon detection of a trigger operation for the fifth bullet screen information; and
displaying first reply information in a target display area in the playing interface of the multimedia resource when the first reply information for the fifth bullet screen information in a discussion page returned by the server is received.

10. The method of claim 9, wherein the first reply information is a content displayed in the playing interface after the fifth bullet screen information is clicked.

11. A server comprising:
one or more processors; and
one or more memories stored thereon computer readable instructions that, when executed by the one or more processors, cause the one or more processors to perform acts comprising:
determining question bullet screen information in multiple pieces of bullet screen information for a multimedia resource, the question bullet screen information comprising a question identifier; and
sending the question bullet screen information to a terminal playing the multimedia resource.

12. The server of claim 11, wherein the sending the question bullet screen information to the terminal playing the multimedia resource comprises sending the question bullet screen information to the terminal playing the multimedia resource so that the terminal displays the question bullet screen information in a display mode corresponding to the question bullet screen information.

13. The server of claim 12, wherein the determining the question bullet screen information in the multiple pieces of bullet screen information for the multimedia resource comprises:
determining multiple pieces of candidate question bullet screen information for the multimedia resource; and
determining the question bullet screen information from the multiple pieces of candidate question bullet screen information.

14. The server of claim 13, wherein the determining the multiple pieces of candidate question bullet screen information for the multimedia resource comprises:
determining bullet screen information comprising a question keyword as the candidate question bullet screen information.

15. The server of claim 11, wherein the acts further comprise:
determining answer bullet screen information corresponding to the question bullet screen information, wherein the answer bullet screen information comprises an answer identifier indicating that the answer bullet screen information is answer bullet screen information corresponding to the question bullet screen information.

16. The server of claim 15, wherein the determining the answer bullet screen information corresponding to the question bullet screen information comprises at least one of the following manners:
determining target bullet screen information matching the question keyword as candidate answer bullet screen information, and determining the answer bullet screen information from the candidate answer bullet screen information, wherein the target bullet screen information is bullet screen information that is received by the server in a target time interval after the question bullet screen information is displayed;
receiving second bullet screen information sent by the terminal, and determining the second bullet screen information as the answer bullet screen information, wherein the second bullet screen information comprises the question identifier of the question bullet screen information; and
acquiring shared information associated with the question bullet screen information from a sharing platform, and determining the answer bullet screen information according to the shared information.

17. The server of claim 15, wherein the acts further comprise:
sending related data of the question bullet screen information and the answer bullet screen information to a discussion page, so that the related data of the question bullet screen information and the answer bullet screen information is displayed on the discussion page.

18. The server of claim 17, wherein the acts further comprise:
acquiring second reply information for the question bullet screen information in the discussion page; and
sending the second reply information to the terminal playing the multimedia resource, so that the terminal displays the second reply information in a display mode corresponding to bullet screen information.

19. The server of claim 18, wherein the second reply information is another reply content after the question bullet screen information and the answer bullet screen information are displayed in the discussion page.

20. One or more memories stored thereon computer readable instructions that, when executed by one or more processors, cause the one or more processors to perform acts comprising:
determining that first bullet screen information is received during playing of a multimedia resource;
determining that the first bullet screen information comprises a question identifier;
determining the first bullet screen information as question bullet screen information; and
displaying the first bullet screen information on a playing interface of the multimedia resource in a display mode corresponding to the question bullet screen information.
